(19) United States
(12) Patent Application Publication
(10) Pub. No.: US 2026/0280126 A1
(43) Pub. Date: Sep. 17, 2026

(54) ANTENNA MODULE AND METHOD FOR MANUFACTURING SAME

(71) Applicant: AMOTECH CO., LTD., Incheon (KR)

(72) Inventors: Kisang LIM, Incheon (KR); Euijin JUNG, Incheon (KR); Jeonghee JEON, Incheon (KR); Jooseung MAENG, Incheon (KR); Jinwon NOH, Incheon (KR)

(73) Assignee: AMOTECH CO., LTD., Incheon (KR)

(21) Appl. No.: 19/166,808

(22) PCT Filed: Mar. 21, 2024
(86) PCT No.: PCT/KR2024/095610

§ 371 Date: Oct. 15, 2025

(30) Foreign Application Priority Data
Mar. 23, 2023 (KR) 10-2023-0037644

(51) Int. Cl. H01Q 7/06; H01Q 1/24; H01Q 1/38

(52) U.S. Cl. CPC H01Q 7/06; H01Q 1/243; H01Q 1/38

(57) ABSTRACT

The present disclosure corresponds to a technology relating to: an antenna module wherein a first antenna substrate is configured such that a hole is formed through an area overlapping both ends of a radiation coil to expose a lower surface of the both ends of the radiation coil, and a second antenna substrate is disposed on the lower surface of the first antenna substrate to minimize increasing thickness and prevent an antenna module from being broken when the module is mounted to a portable terminal; and a method for manufacturing same.

### TECHNICAL FIELD

The present disclosure is directed to a technology relating to an antenna module including a coil serving as a radiator, and a method of manufacturing the same.

### BACKGROUND ART

Portable terminals are equipped with a wireless charging function. Wireless charging is a method of charging a battery embedded in a portable terminal through wireless power transfer between a wireless power transfer coil mounted in the portable terminal and a wireless power transfer coil mounted in a charger.

Recently, a high-power wireless power transfer technology of 20 W or more has been developed and applied for high-speed wireless charging of portable terminals.

Manufacturers employ various types of antennas for high-power wireless power transfer. For example, a manufacturer employs a hybrid bonded combo antenna formed by bonding a wireless power transfer coil and a printed circuit board type antenna as an antenna for high-power wireless power transfer.

However, a conventional hybrid bonded combo antenna has a problem in that a defect rate increases as a bonding strength decreases during a manufacturing process.

In addition, the conventional hybrid bonded combo antenna has a problem in that, since a radiator (antenna) is configured by attaching a coil formed of copper to a coverlay film (encapsulant), an adhesive force between the coverlay film and the coil is reduced, thereby causing the coil to be separated (delaminated) from the coverlay film.

Furthermore, the conventional hybrid bonded combo antenna has a problem in that, as the adhesive force between the coil and the coverlay film is reduced, a spacing and a shape of the coil are deformed, thereby causing deterioration of antenna performance.

The contents described in the Background Art are to help the understanding of the background of the disclosure, and may include contents that are not a disclosed conventional technology.

### SUMMARY OF INVENTION

### Technical Problem

The present disclosure has been proposed to solve the above-described problems, and an object of the present disclosure is to provide an antenna module and a method of manufacturing the same, in which a second antenna substrate is disposed on a lower surface of a first antenna substrate, and a bonding hole is formed in a coverlay film to expose an end of a coil downward, thereby minimizing an increase in thickness, and preventing damage of the antenna module.

Another object of the present disclosure is to provide an antenna module and a method of manufacturing the same, in which one surface of the coil in contact with the coverlay film is oxide-coated to prevent deterioration in adhesion between the coverlay film and the coil.

Still another object of the present disclosure is to provide an antenna module and a method of manufacturing the same, in which a first antenna substrate and a second antenna substrate are primarily bonded through an adhesive substrate, and the first antenna substrate and the second antenna substrate are secondarily bonded through a fusion bonding process.

### Solution to Problem

To achieve the above objects, an antenna module according to an embodiment of the present disclosure may include a first antenna substrate on which a coil is formed, and a second antenna substrate disposed under the first antenna substrate and on which a bonding pattern bonded to the coil is formed. The first antenna substrate may include a first sheet having a bonding hole formed in an area overlapping the bonding pattern. An end of the coil is exposed to a lower side of the first antenna substrate through the bonding hole and disposed to face the bonding pattern.

The antenna module may further include a metal substrate disposed under the first antenna substrate and the second antenna substrate. The metal substrate may include a first area overlapping the first antenna substrate, and a second area overlapping the second antenna substrate. A portion of the second area may overlap the first antenna substrate with the second antenna substrate interposed therebetween.

A cross-section of the coil may include a first metal layer, and a second metal layer disposed under the first metal layer. The second metal layer may include a brown oxide layer or a black oxide layer formed by oxidizing a lower portion of the first metal layer through an oxide process. The cross-section of the coil may further include a third metal layer disposed on an upper portion of the first metal layer.

The first antenna substrate may further include a first coil configured to form a first loop wound on an upper surface of the first sheet, and a second coil configured to form a second loop wound on the upper surface of the first sheet. The first sheet may include a first bonding hole formed at a position overlapping a first end of the first coil, and formed to expose the first end of the first coil to a lower surface of the first sheet, a second bonding hole formed at a position overlapping a second end of the first coil, and formed to expose the second end of the first coil to the lower surface of the first sheet, a third bonding hole formed at a position overlapping a first end of the second coil, and formed to expose the first end of the second coil to the lower surface of the first sheet, and a fourth bonding hole formed at a position overlapping a second end of the second coil, and formed to expose the second end of the second coil to the lower surface of the first sheet.

The antenna module according to an embodiment of the present disclosure may further include an adhesive substrate interposed between the first antenna substrate and the second antenna substrate. The adhesive substrate may include a fifth bonding hole formed to overlap the first end of the first coil and the first bonding hole and expose the first end of the first coil to a lower surface of the first antenna substrate, a sixth bonding hole formed to overlap the second end of the first coil and the second bonding hole and expose the second end of the first coil to the lower surface of the first antenna substrate, a seventh bonding hole formed to overlap the first end of the second coil and the third bonding hole and expose the first end of the second coil to the lower surface of the first antenna substrate, and an eighth bonding hole formed to overlap the second end of the second coil and the fourth bonding hole and expose the second end of the second coil to the lower surface of the first antenna substrate.

The second antenna substrate may include a first base substrate disposed under the first sheet, a first bonding pattern disposed on an upper surface of the first base substrate and connected to the first end of the first coil, a second bonding pattern disposed on the upper surface of the first base substrate so as to be spaced apart from the first bonding pattern, and connected to the second end of the first coil, a third bonding pattern disposed on the upper surface of the first base substrate so as to be spaced apart from the first bonding pattern and the second bonding pattern, and connected to the first end of the second coil, and a fourth bonding pattern disposed on the upper surface of the first base substrate so as to be spaced apart from the first to the third bonding patterns, and connected to the second end of the second coil.

The first antenna substrate may include a first coil configured to form a first loop wound on an upper surface of the first sheet, a second coil disposed on the upper surface of the first sheet, and a third coil configured to form a second loop wound on the upper surface of the first sheet. The first sheet may include a first bonding hole formed at a position overlapping a second end of the first coil, and formed to expose the second end of the first coil to a lower surface of the first sheet, a second bonding hole formed at a position overlapping a second end of the second coil, and formed to expose the second end of the second coil to the lower surface of the first sheet, a third bonding hole formed at a position overlapping a first end of the third coil, and formed to expose the first end of the third coil to the lower surface of the first sheet, and a fourth bonding hole formed at a position overlapping a second end of the third coil, and formed to expose the second end of the third coil to the lower surface of the first sheet.

The antenna module according to an embodiment of the present disclosure may further include an adhesive substrate interposed between the first antenna substrate and the second antenna substrate. The adhesive substrate may include a fifth bonding hole formed to overlap the second end of the first coil and the first bonding hole and expose the second end of the first coil to a lower surface of the first antenna substrate, a sixth bonding hole formed to overlap the second end of the second coil and the second bonding hole and expose the second end of the second coil to the lower surface of the first antenna substrate, a seventh bonding hole formed to overlap the first end of the third coil and the third bonding hole and expose the first end of the third coil to the lower surface of the first antenna substrate, and an eighth bonding hole formed to overlap the second end of the third coil and the fourth bonding hole and expose the second end of the third coil to the lower surface of the first antenna substrate.

The antenna module according to an embodiment of the present disclosure may further include a connection substrate disposed on an upper surface of the first antenna substrate. The connection substrate may include a connection pattern configured to connect the first coil and the second coil. A first end of the connection pattern may be connected to a first end of the first coil, and a second end of the connection pattern may be connected to a first end of the second coil.

The second antenna substrate may include a first base substrate disposed under the first sheet, a first bonding pattern disposed on an upper surface of the first base substrate and connected to the second end of the first coil, a second bonding pattern disposed on the upper surface of the first base substrate so as to be spaced apart from the first bonding pattern, and connected to the second end of the second coil, a third bonding pattern disposed on the upper surface of the first base substrate so as to be spaced apart from the first bonding pattern and the second bonding pattern, and connected to the first end of the third coil, and a fourth bonding pattern disposed on the upper surface of the first base substrate so as to be spaced apart from the first to the third bonding patterns, and connected to the second end of the third coil.

To achieve the above objects, a method of manufacturing an antenna module according to an embodiment of the present disclosure may include preparing a first antenna substrate on which a coil is formed, preparing a second antenna substrate, mounting the second antenna substrate to a jig, mounting the first antenna substrate to the jig such that the first antenna substrate is disposed on an upper portion of the second antenna substrate, and bonding the first antenna substrate and the second antenna substrate. In the preparing of the first antenna substrate, the first antenna substrate in which an end of the coil is exposed to a lower side of the first antenna substrate through a bonding hole may be prepared.

In the preparing of the first antenna substrate, the first antenna substrate may be prepared, the first antenna substrate including the coil having a cross-section including a first metal layer and a second metal layer disposed under the first metal layer and formed by oxidizing the first metal layer.

The preparing of the first antenna substrate may include preparing a metal sheet, preparing a coverlay film, forming a first half-groove in an upper surface of the metal sheet, forming a second metal layer on the upper surface of the metal sheet in which the first half-groove is formed, laminating the coverlay film on the upper surface of the metal sheet on which the second metal layer is formed, and forming a second half-groove in a lower surface of the metal sheet. In the preparing of the coverlay film, the coverlay film having a bonding hole formed to expose an end of a coil formed by the metal sheet may be prepared.

In the preparing of the second metal layer, a brown oxide layer or a black oxide layer may be formed by oxidizing a lower portion of the metal sheet through an oxide process. The preparing of the first antenna substrate may further include forming a third metal layer on a lower surface of the metal sheet in which the second half-groove is formed.

In the laminating of the coverlay film, the coverlay film may be laminated such that the bonding hole formed in the coverlay film overlaps the end of the coil.

The method according to an embodiment of the present disclosure may further include, before the laminating of the coverlay film, mounting an adhesive substrate to the jig such that the adhesive substrate is disposed on an upper portion of the second antenna substrate. In the mounting of the adhesive substrate, the adhesive substrate having a bonding hole in an area overlapping the end of the coil formed by the metal sheet may be mounted. The bonding hole of the adhesive substrate may overlap the bonding hole of the first antenna substrate.

The method according to an embodiment of the present disclosure may further include bonding a metal substrate to a lower surface of the first antenna substrate and a lower surface of the second antenna substrate. A first area of the metal substrate may overlap the first antenna substrate. A second area of the metal substrate may overlap the second antenna substrate. A portion of the second area may overlap the first antenna substrate with the second antenna substrate interposed therebetween.

### Advantageous Effects of Invention

According to the present disclosure, an antenna module and a method of manufacturing the same provide an effect of preventing deterioration in adhesion between a coil and a coverlay film by forming a first antenna substrate in such a way that the coil, one surface of which is oxide-coated, is bonded to the coverlay film.

Furthermore, in the antenna module and the method of manufacturing the same, because the first antenna substrate is formed by bonding the coil, one surface of which is oxide-coated, to the coverlay film, deterioration in adhesion between the coil and the coverlay film may be prevented, thereby providing an effect of preventing a change in spacing, shape, or the like of the coil.

Furthermore, in the antenna module and the method of manufacturing the same, because the first antenna substrate is formed by bonding the coil, one surface of which is oxide-coated, to the coverlay film, a change in spacing, shape, or the like of the coil may be prevented, thereby providing an effect of preventing deterioration in antenna performance.

In addition, in the antenna module and the method of manufacturing the same, the first antenna substrate and a second antenna substrate are primarily bonded through an adhesive substrate, and the first antenna substrate and the second antenna substrate are secondarily bonded through a fusion bonding process. Accordingly, an effect of improving workability in antenna manufacturing and increasing adhesion strength between the first antenna substrate and the second antenna substrate may be obtained.

Moreover, in the antenna module and the method of manufacturing the same, because the first antenna substrate and the second antenna substrate are primarily bonded through the adhesive substrate before the first antenna substrate and the second antenna substrate are secondarily bonded through the fusion bonding process, adhesion strength between the first antenna substrate and the second antenna substrate may be increased, thereby providing an effect of improving alignment accuracy between the coil and a pattern.

Furthermore, in the antenna module and the method of manufacturing the same, because the first antenna substrate and the second antenna substrate are primarily bonded through the adhesive substrate before the first antenna substrate and the second antenna substrate are secondarily bonded through the fusion bonding process, an effect of minimizing a defect rate caused by misalignment and increasing yield may be obtained.

Furthermore, in the antenna module and the method of manufacturing the same, because the first antenna substrate and the second antenna substrate are primarily bonded through the adhesive substrate before the first antenna substrate and the second antenna substrate are secondarily bonded through the fusion bonding process, an effect of minimizing a change in antenna performance caused by misalignment may be obtained.

In addition, in the antenna module and the method of manufacturing the same, because the second antenna substrate is disposed on a lower surface of the first antenna substrate, an effect of preventing deterioration in antenna performance, which may occur when the second antenna substrate is dented by a rear housing of a portable terminal during a process of mounting the antenna module in the portable terminal, may be obtained.

Moreover, in the antenna module and the method of manufacturing the same, a bonding hole is formed in the coverlay film (that is, a first sheet) so that an end of the coil is exposed downward. Accordingly, the effect of minimizing an increase in thickness may be obtained even when the second antenna substrate is disposed on the lower surface of the first antenna substrate.

### BRIEF DESCRIPTION OF DRAWINGS

FIG. 1 is an exploded perspective view for explaining an antenna module according to a first embodiment of the present disclosure.

FIG. 2 is a view for explaining a first antenna substrate of FIG. 1.

FIGS. 3 and 4 are views for explaining a first sheet of FIG. 2.

FIG. 5 is a view for explaining first to third coils of FIG. 2.

FIG. 6 is a view for explaining a connection substrate of FIG. 1.

FIGS. 7 and 8 are views for explaining a second antenna substrate of FIG. 1.

FIG. 9 is a cross-sectional view taken along line A-A′ of the second antenna substrate of FIG. 7.

FIG. 10 is a view for explaining a modification of the second antenna substrate of FIG. 1.

FIG. 11 is a view for explaining a metal substrate of FIG. 1.

FIG. 12 is an exploded perspective view for explaining a modification of an antenna module according to a first embodiment of the present disclosure.

FIG. 13 is a view for explaining an adhesive substrate of FIG. 12.

FIG. 14 is an exploded perspective view for explaining an antenna module according to a second embodiment of the present disclosure.

FIG. 15 is a view for explaining a first antenna substrate of FIG. 14.

FIG. 16 is a view for explaining a first sheet of FIG. 15.

FIGS. 17 and 18 are views for explaining a second antenna substrate of FIG. 14.

FIG. 19 is a view for explaining a modification of the second antenna substrate of FIG. 14.

FIG. 20 is an exploded perspective view for explaining a modification of an antenna module according to a second embodiment of the present disclosure.

FIG. 21 is a view for explaining an adhesive substrate of FIG. 20.

FIG. 22 is a flowchart for explaining a method of manufacturing an antenna module according to an embodiment of the present disclosure.

FIG. 23 is a flowchart for explaining the step of preparing a first antenna substrate of FIG. 22.

FIG. 24 is a flowchart for explaining a modification of a method of manufacturing an antenna module according to an embodiment of the present disclosure.

### DESCRIPTION OF EMBODIMENTS

Hereinafter, embodiments of the present disclosure are described in detail with reference to the accompanying drawings.

Embodiments are provided to more fully explain the present disclosure to a person having ordinary knowledge in the art to which the present disclosure pertains. The following embodiments may be modified in various other forms, and the scope of the present disclosure is not limited to the following embodiments. Rather, these embodiments are provided to make the present disclosure more thorough and complete and to fully convey the spirit of the present disclosure.

Terms used in this specification are used to describe a specific embodiment, and are not intended to limit the present disclosure. Furthermore, in this specification, an expression of the singular number may include an expression of the plural number unless clearly defined otherwise in the context.

In the description of the embodiments, when it is described that each layer (film), area, pattern, or structure is formed “on” or “under” each substrate, layer (film), area, pad, or pattern, this includes both expressions, including that a layer is formed on another layer “directly” or “with a third layer interposed between the two layers (indirectly)”. Furthermore, a criterion for the term “on or under of each layer” is described based on the drawings.

The drawings are merely for enabling the spirit of the present disclosure to be understood, and it should not be interpreted that the scope of the present disclosure is limited by the drawings. Furthermore, in the drawings, a relative thickness or length or a relative size may be exaggerated for convenience and the clarity of description.

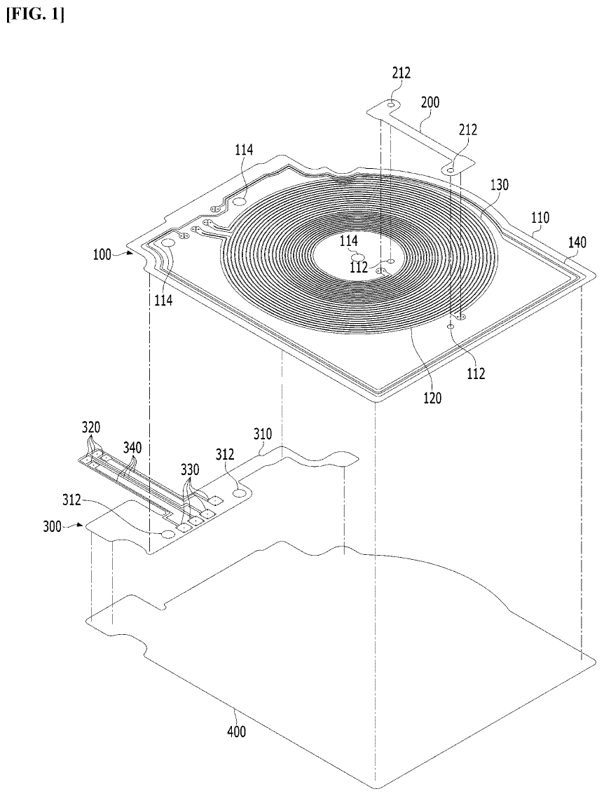

Referring to FIG. 1, an antenna module according to a first embodiment of the present disclosure includes a first antenna substrate 100, a connection substrate 200, a second antenna substrate 300, and a metal substrate 400. The first antenna substrate 100 and the second antenna substrate 300 may be bonded through a fusion bonding process. The first antenna substrate 100 and the second antenna substrate 300 may undergo primary provisional bonding through an adhesive process, and then secondary bonding through a fusion process. The fusion process includes, as an example, a thermal fusion process, and includes physically and electrically bonding the first antenna substrate 100 to the second antenna substrate 300 (and/or the connection substrate 200). Here, in FIG. 1, the connection substrate 200 is illustrated as being disposed on an upper side of the first antenna substrate 100, but is not limited thereto and may be disposed on a lower side of the first antenna substrate 100 and interposed between the first antenna substrate 100 and the metal substrate 400.

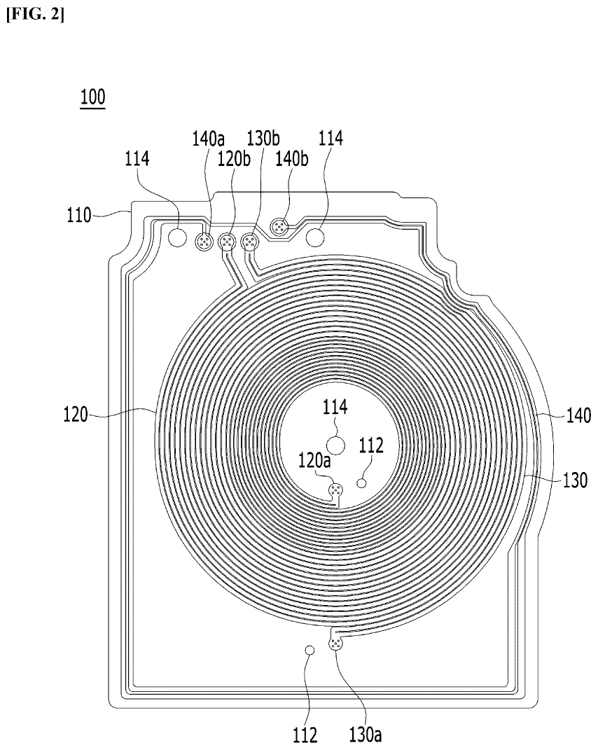

Referring to FIG. 2, the first antenna substrate 100 includes a first sheet 110, a first coil 120, a second coil 130, and a third coil 140. The first coil 120 and the second coil 130 form a first radiation coil, and the third coil 140 forms a second radiation coil. In an embodiment of the present disclosure, the first antenna substrate 100 is illustrated and described as including the first to the third coils 120 to 140, but is not limited thereto and may be configured to include one or more coils.

The first sheet 110 is formed of a coverlay film. The first sheet 110 is a film formed of a resin material, and as an example, may be formed of a resin material such as polyimide (PI) or polypropylene (PP).

The first sheet 110 has a pair of first jig holes 112 formed to align the first antenna substrate 100 and the connection substrate 200 during a process of manufacturing the antenna module, and a plurality of second jig holes 114 formed to align the first antenna substrate 100 and the second antenna substrate 300. The first jig holes 112 and the second jig holes 114 are formed to pass through the first sheet 110.

A plurality of bonding holes 116 are formed in the first sheet 110. The plurality of bonding holes 116 are formed to pass through the first sheet 110. The bonding holes 116 are formed at positions overlapping ends of the coils disposed on an upper surface of the first sheet 110. The bonding holes 116 expose the overlapping ends of the coils to a lower side of the first sheet 110. To electrically connect the coils of the first antenna substrate 100 to patterns formed on the second antenna substrate 300, the ends of the coils formed on the upper surface of the first sheet 110 are exposed to a lower surface of the first sheet 110.

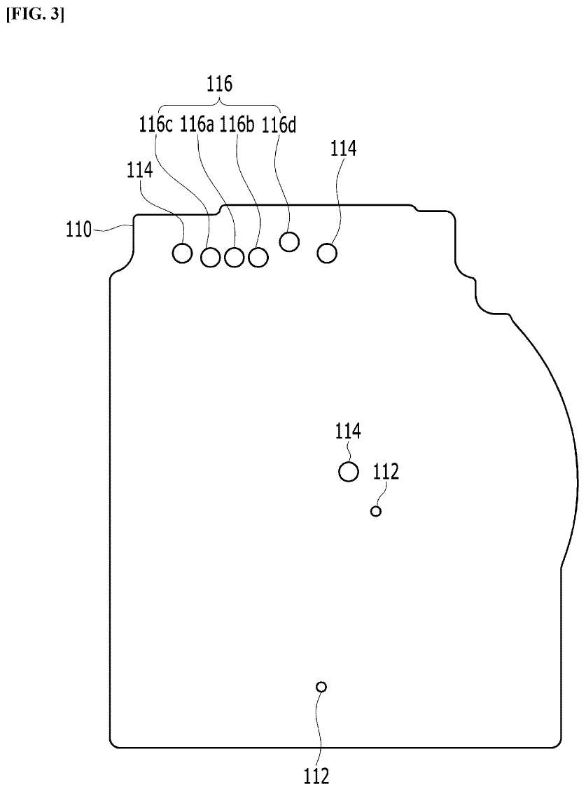

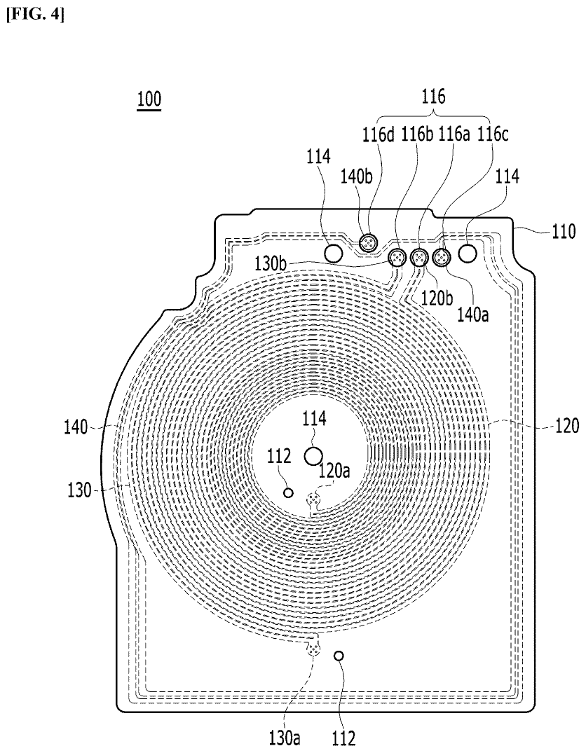

Referring to FIGS. 3 and 4, a first bonding hole 116a, a second bonding hole 116b, a third bonding hole 116c, and a fourth bonding hole 116d are formed in the first sheet 110.

The first bonding hole 116a is formed at a position overlapping a second end 120b of the first coil 120 to expose the second end 120b of the first coil 120 to the lower surface of the first sheet 110. The first bonding hole 116a is formed, within an entire area of the first sheet 110, in an area overlapping the second end 120b of the first coil 120 disposed on the first sheet 110.

The second bonding hole 116b is formed at a position overlapping a second end 130b of the second coil 130 to expose the second end 130b of the second coil 130 to the lower surface of the first sheet 110. The second bonding hole 116b is formed, within the entire area of the first sheet 110, in an area overlapping the second end 130b of the second coil 130 disposed on the first sheet 110.

The third bonding hole 116c is formed at a position overlapping a first end 140a of the third coil 140 to expose the first end 140a of the third coil 140 to the lower surface of the first sheet 110. The third bonding hole 116c is formed, within the entire area of the first sheet 110, in an area overlapping the first end 140a of the third coil 140 disposed on the first sheet 110.

The fourth bonding hole 116d is formed at a position overlapping the second end 140b of the third coil 140 to expose the second end 140b of the third coil 140 to the lower surface of the first sheet 110. The fourth bonding hole 116d is formed, within the entire area of the first sheet 110, in an area overlapping the second end 140b of the third coil 140 disposed on the first sheet 110.

In the case where the connection substrate 200 is disposed under the first antenna substrate 100, the first sheet 110 may further have a bonding hole formed in an area overlapping a first end 120a of the first coil 120, and a bonding hole formed in an area overlapping a first end 130a of the second coil 130.

The first coil 120 is disposed on the upper surface of the first sheet 110. The first coil 120 may be, for example, a wireless power transfer coil.

The first coil 120 is wound a plurality of times on the upper surface of the first sheet 110 to form a first loop. The first coil 120 is wound around an imaginary first winding axis vertically penetrating the first sheet 110, thereby forming the first loop. The first end 120a of the first coil 120 is disposed in an inner circumferential area of the first loop. The second end 120b of the first coil 120 is disposed in an outer circumferential area of the first loop so as to overlap the first bonding hole 116a and is exposed to the lower surface of the first sheet 110 through the first bonding hole 116a.

The second coil 130 is disposed on the upper surface of the first sheet 110 to form the first radiation coil together with the first coil 120. The first radiation coil may be, for example, a wireless power transfer coil.

The second coil 130 is disposed in the outer circumferential area of the first loop formed by the first coil 120. The second coil 130 is spaced apart from the first loop by a predetermined interval and is disposed along the outer circumference of the first loop. The second end 130b of the second coil 130 is disposed so as to overlap the second bonding hole 116b and is exposed to the lower surface of the first sheet 110 through the second bonding hole 116b.

The first end 130a of the second coil 130 is disposed adjacent to the first end 120a of the first coil 120. The second end 130b of the second coil 130 is disposed adjacent to the second end 120b of the first coil 120. In this case, a linear distance between the second end 130b of the second coil 130 and the first end 120a of the first coil 120 may be shorter than a linear distance between the second end 130b of the second coil 130 and the second end 120b of the first coil 120, as an example.

The third coil 140 is disposed on an upper surface of the first sheet 110. The third coil 140 is disposed on the upper surface of the first sheet 110 so as to be spaced apart from the first coil 120. The third coil 140 is disposed in the outer circumferential area of the first loop formed by the first coil 120. In other words, the first loop formed by the first coil 120 is disposed in an inner circumferential area of a second loop formed by the third coil 140. Here, the third coil 140 forms a second radiation coil, and as an example, the second radiation coil may be a coil for near-field communication.

The third coil 140 is wound one or more times on the upper surface of the first sheet 110 to form the second loop. The third coil 140 is wound around an imaginary second winding axis vertically penetrating the first sheet 110, thereby forming the second loop. The second winding axis may be the same axis as the first winding axis.

The first end 140a of the third coil 140 is disposed in the inner circumferential area of the second loop. The first end 140a of the third coil 140 is disposed so as to overlap the third bonding hole 116c and is exposed to the lower surface of the first sheet 110 through the third bonding hole 116c.

The second end 140b of the third coil 140 is disposed in an outer circumferential area of the second loop. The second end 140b of the third coil 140 is disposed so as to overlap the fourth bonding hole 116d and is exposed to the lower surface of the first sheet 110 through the fourth bonding hole 116d.

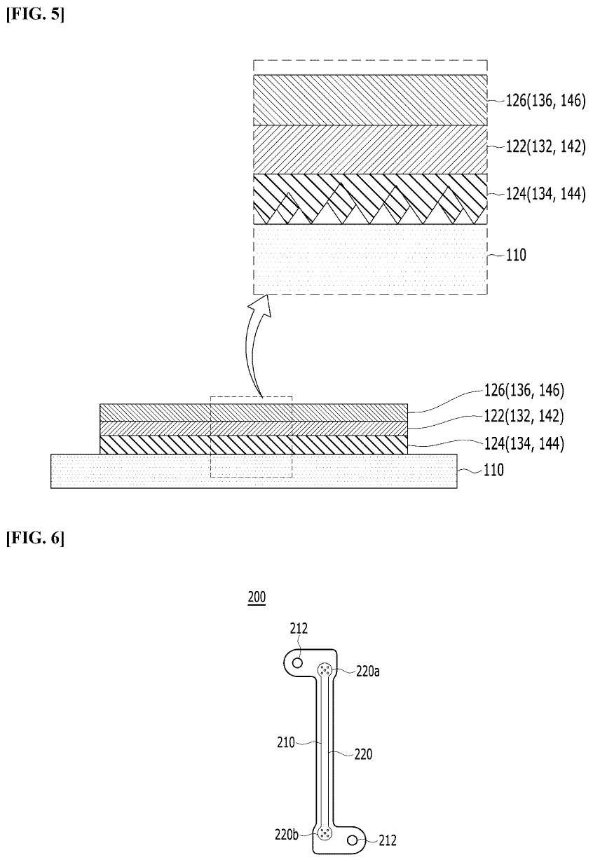

Referring to FIG. 5, a cross-section of each coil includes a first metal layer 122, 132, or 142, a second metal layer 124, 134, or 144, and a third metal layer 126, 136, or 146.

The first metal layer 122, 132, or 142 is disposed over the first sheet 110. The first metal layer 122, 132, or 142 may be, for example, copper (Cu), which is commonly used for a radiator.

The second metal layer 124, 134, or 144 is disposed under the first metal layer 122, 132, or 142 and is interposed between the first sheet 110 and the first metal layer 122, 132, or 142. The second metal layer 124, 134, or 144 is formed under the first metal layer 122, 132, or 142 through a brown oxide process or a black oxide process. The second metal layer 124, 134, or 144 is a blackened layer formed through an oxide process. The second metal layer 124, 134, or 144 is formed by oxidizing the lower surface of the first metal layer 122, 132, or 142 through an oxide process. The second metal layer 124, 134, or 144 includes a plurality of irregularities (needles, bends) formed in a direction from the first metal layer 122, 132, or 142 toward the first sheet 110. The second metal layer 124, 134, or 144 is formed by oxidizing the lower surface of the first metal layer 122, 132, or 142 through an oxide process and includes the plurality of needles formed as a result of the oxidation treatment. The second metal layer 124, 134, or 144 is formed through the oxide process and has a black or brown color depending on the oxide process. Accordingly, a lower surface of the coil has a black or brown color.

The third metal layer 126, 136, or 146 is disposed on the first metal layer 122, 132, or 142. The third metal layer 126, 136, or 146 may be formed of, for example, tin (Sn). Accordingly, an upper surface of the coil has a silver color.

In FIG. 5, for convenience of explanation of an embodiment of the present disclosure, the coil is illustrated and described as including the first to the third metal layer metal layer 122 to 126, 132 to 136, or 142 to 146. However, the disclosure is not limited thereto, and the coil may be formed of only the first metal layer 122, 132, or 142 and the second metal layer 124, 134, or 144.

As such, in the antenna module, as the second metal layer 124, 134, or 144 is formed on the lower surface of the coil that contacts the first sheet 110, adhesion (contact force) between the first sheet 110 and the coil can be reinforced, thereby preventing the coil from being separated from the first sheet 110.

Furthermore, in the antenna module, because the adhesion between the coil and the first sheet 110 is reinforced, the coil and the coverlay film (that is, the first sheet 110) can be prevented from being separated from each other, thereby minimizing a defect rate during manufacturing.

In addition, in the antenna module, because the adhesion between the coil and the coverlay film is reinforced, a spacing or a shape of the coil can be prevented from being deformed, thereby preventing deterioration of antenna performance.

The connection substrate 200 is disposed on the upper surface of the first sheet 110. The connection substrate 200 electrically connects the first end 120a of the first coil 120 and the first end 130a of the second coil 130. The connection substrate 200 may be primarily bonded to the antenna substrate through an adhesive sheet (not shown) and may be secondarily bonded through fusion bonding.

Referring to FIG. 6, the connection substrate 200 includes a first base substrate 210 and a first connection pattern 220.

The first base substrate 210 is formed of a printed circuit board. A pair of third jig holes 212 are formed in the first base substrate 210 to align the first antenna substrate 100 and the connection substrate 200. The pair of third jig holes 212 are formed to pass through the first base substrate 210 and are formed at positions corresponding to the pair of first jig holes 112 formed in the first sheet 110. As the connection substrate 200 is disposed on an upper surface of the first antenna substrate 100, the pair of third jig holes 212 overlap the pair of first jig holes 112, thereby forming a pair of jig holes through which guide protrusions of a jig pass.

The first connection pattern 220 is disposed on a lower surface of the first base substrate 210. The first connection pattern 220 is formed on the lower surface of the first base substrate 210 through a printing process. Here, the lower surface of the first base substrate 210 is a surface facing the upper surface of the first antenna substrate 100 (that is, the upper surface of the first sheet 110) when the connection substrate 200 is disposed on the upper surface of the first antenna substrate 100.

A first end 220a of the first connection pattern 220 is electrically connected to the first end 120a of the first coil 120. A second end 220b of the first connection pattern 220 is electrically connected to the first end 130a of the second coil 130. Accordingly, the first connection pattern 220 electrically connects the first coil 120 and the second coil 130 to form the wireless power transfer coil together with the first coil 120 and the second coil 130.

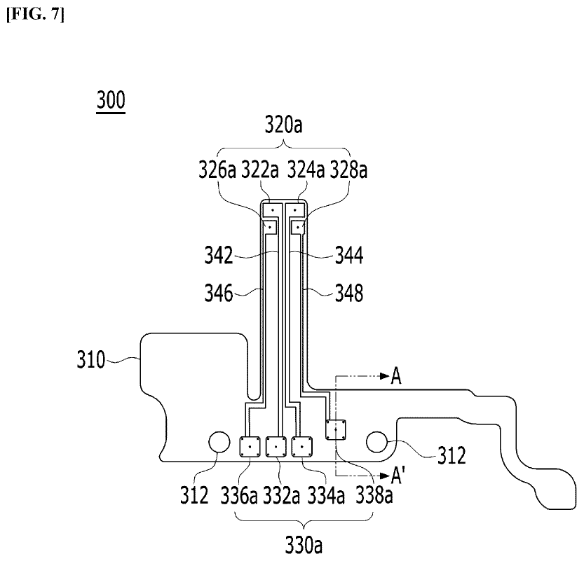

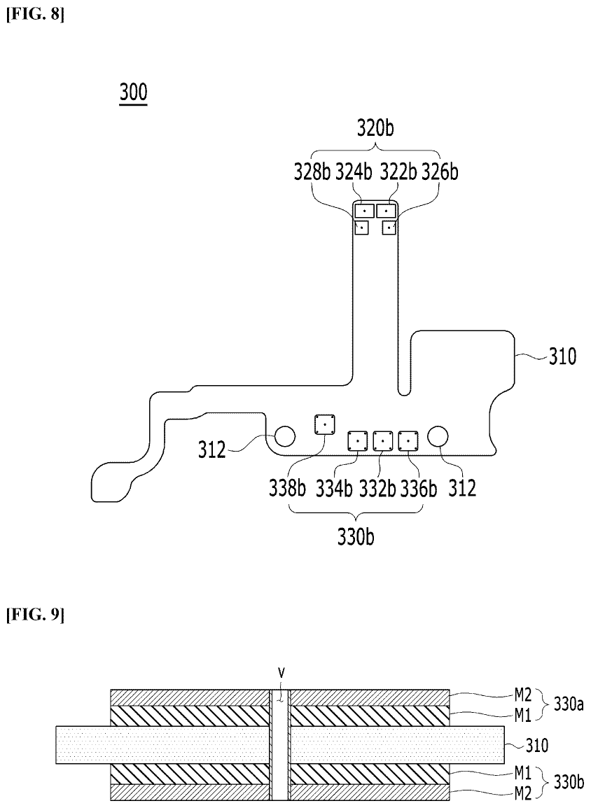

Referring to FIGS. 7 and 8, the second antenna substrate 300 includes a second base substrate 310, a terminal pattern 320, a bonding pattern 330, a second connection pattern 342, a third connection pattern 344, a fourth connection pattern 346, and a fifth connection pattern 348.

The second antenna substrate 300 is disposed on a lower surface of the first antenna substrate 100. Here, the lower surface of the first antenna substrate 100 is a surface facing a battery disposed in a portable terminal when the antenna module is mounted in the portable terminal. The upper surface of the first antenna substrate 100 is a surface facing a rear housing of the portable terminal when the antenna module is mounted in the portable terminal.

The second base substrate 310 is formed of a flexible printed circuit board (FPCB). The second base substrate 310 may be formed of the same material as the first base substrate 210 or may be formed of a material different therefrom.

A plurality of fourth jig holes 312 are formed in the second base substrate 310 to align the first antenna substrate 100, the second antenna substrate 300, and an adhesive substrate 500 during the process of manufacturing the antenna module. Here, one or more fourth jig holes 312 are formed to pass through the second base substrate 310 and are formed at positions corresponding to the plurality of second jig holes 114 formed in the first sheet 110. As the second antenna substrate 300 is disposed on the upper surface of the first antenna substrate 100, the plurality of fourth jig holes 312 overlap the plurality of second jig holes 114, thereby forming a plurality of jig holes through which guide protrusions of a jig pass.

The terminal pattern 320 is a terminal that connects the first radiation coil formed by the first coil 120 and the second coil 130 and the second radiation coil formed by the third coil 140 to an external device. The terminal pattern 320 may be configured to include at least one of an upper terminal pattern 320a disposed on an upper surface of the second base substrate 310 and a lower terminal pattern 320b disposed on a lower surface of the second base substrate 310.

The terminal pattern 320 may be configured to include a first terminal pattern 322, a second terminal pattern 324, a third terminal pattern 326, and a fourth terminal pattern 328, as an example. The first to the fourth terminal patterns 322 to 328 are disposed to be spaced apart from each other by a predetermined interval.

The first terminal pattern 322 is connected to the second connection pattern 342. The first terminal pattern 322 may be configured to include a first upper terminal pattern 322a disposed on the upper surface of the second base substrate 310 and a first lower terminal pattern 322b disposed on the lower surface of the second base substrate 310. The first upper terminal pattern 322a and the first lower terminal pattern 322b are disposed to overlap each other with the second base substrate 310 interposed therebetween and are electrically connected through a via hole. The first terminal pattern 322 may also be configured with either the first upper terminal pattern 322a or the first lower terminal pattern 322b.

The second terminal pattern 324 is connected to the third connection pattern 344. The second terminal pattern 324 may be configured to include a second upper terminal pattern 324a disposed on the upper surface of the second base substrate 310 and a second lower terminal pattern 324b disposed on the lower surface of the second base substrate 310. The second upper terminal pattern 324a and the second lower terminal pattern 324b are disposed to overlap each other with the second base substrate 310 interposed therebetween and are electrically connected through a via hole. The second terminal pattern 324 may also be configured with either the second upper terminal pattern 324a or the second lower terminal pattern 324b.

The third terminal pattern 326 is connected to the fourth connection pattern 346. The third terminal pattern 326 may be configured to include a third upper terminal pattern 326a disposed on the upper surface of the second base substrate 310 and a third lower terminal pattern 326b disposed on the lower surface of the second base substrate 310. The third upper terminal pattern 326a and the third lower terminal pattern 326b are disposed to overlap each other with the second base substrate 310 interposed therebetween and are electrically connected through a via hole. The third terminal pattern 326 may also be configured with either the third upper terminal pattern 326a or the third lower terminal pattern 326b.

The fourth terminal pattern 328 is connected to the fifth connection pattern 348. The fourth terminal pattern 328 may be configured to include a fourth upper terminal pattern 328a disposed on the upper surface of the second base substrate 310 and a fourth lower terminal pattern 328b disposed on the lower surface of the second base substrate 310. The fourth upper terminal pattern 328a and the fourth lower terminal pattern 328b are disposed to overlap each other with the second base substrate 310 interposed therebetween and are electrically connected through a via hole. The fourth terminal pattern 328 may also be configured with either the fourth upper terminal pattern 328a or the fourth lower terminal pattern 328b.

The bonding pattern 330 is a pattern that connects the first radiation coil and the second radiation coil to the terminal pattern 320. The bonding pattern 330 may be configured to include an upper bonding pattern 330a disposed on the upper surface of the second base substrate 310 and a lower bonding pattern 330b disposed on the lower surface of the second base substrate 310.

A first bonding pattern 332 connects the second end 120b of the first coil 120 and the first terminal pattern 322. In other words, the first bonding pattern 332 is connected to the second connection pattern 342 and is electrically connected to the second end 120b of the first coil 120, thereby electrically connecting the second end 120b of the first coil 120 and the first terminal pattern 322.

The first bonding pattern 332 is configured to include a first upper bonding pattern 332a disposed on the upper surface of the second base substrate 310 and a first lower bonding pattern 332b disposed on the lower surface of the second base substrate 310. The first upper bonding pattern 332a and the first lower bonding pattern 332b are disposed to overlap each other with the second base substrate 310 interposed therebetween and are electrically connected through a via hole.

A second bonding pattern 334 connects the second end 130b of the second coil 130 and the second terminal pattern 324. In other words, the second bonding pattern 334 is connected to the third connection pattern 344 and is electrically connected to the second end 130b of the second coil 130, thereby electrically connecting the second end 130b of the second coil 130 and the second terminal pattern 324.

The second bonding pattern 334 is configured to include a second upper bonding pattern 334a disposed on the upper surface of the second base substrate 310 and a second lower bonding pattern 334b disposed on the lower surface of the second base substrate 310. The second upper bonding pattern 334a and the second lower bonding pattern 334b are disposed to overlap each other with the second base substrate 310 interposed therebetween and are electrically connected through a via hole.

The third bonding pattern 336 connects the first end 140a of the third coil 140 and the third terminal pattern 326. In other words, the third bonding pattern 336 is connected to the fourth connection pattern 346 and is electrically connected to the first end 140a of the third coil 140, thereby electrically connecting the first end 140a of the third coil 140 and the third terminal pattern 326.

The third bonding pattern 336 is configured to include a third upper bonding pattern 336a disposed on the upper surface of the second base substrate 310 and a third lower bonding pattern 336b disposed on the lower surface of the second base substrate 310. The third upper bonding pattern 336a and the third lower bonding pattern 336b are disposed to overlap each other with the second base substrate 310 interposed therebetween and are electrically connected through a via hole.

A fourth bonding pattern 338 connects the second end 140b of the third coil 140 and the fourth terminal pattern 328. In other words, the fourth bonding pattern 338 is connected to the fifth connection pattern 348 and is electrically connected to the second end 140b of the third coil 140, thereby electrically connecting the second end 140b of the third coil 140 and the fourth terminal pattern 328.

The fourth bonding pattern 338 is configured to include a fourth upper bonding pattern 338a disposed on the upper surface of the second base substrate 310 and a fourth lower bonding pattern 338b disposed on the lower surface of the second base substrate 310. The fourth upper bonding pattern 338a and the fourth lower bonding pattern 338b are disposed to overlap each other with the second base substrate 310 interposed therebetween and are electrically connected through a via hole.

The bonding pattern 330 is a fusion bonding point used in a thermal fusion bonding process of secondarily bonding the first antenna substrate 100 and the second antenna substrate 300 that are primarily bonded by the adhesive substrate 500. In other words, the first antenna substrate 100 and the second antenna substrate 300 are bonded through the thermal fusion bonding process with respect to the bonding pattern 330 and are electrically connected.

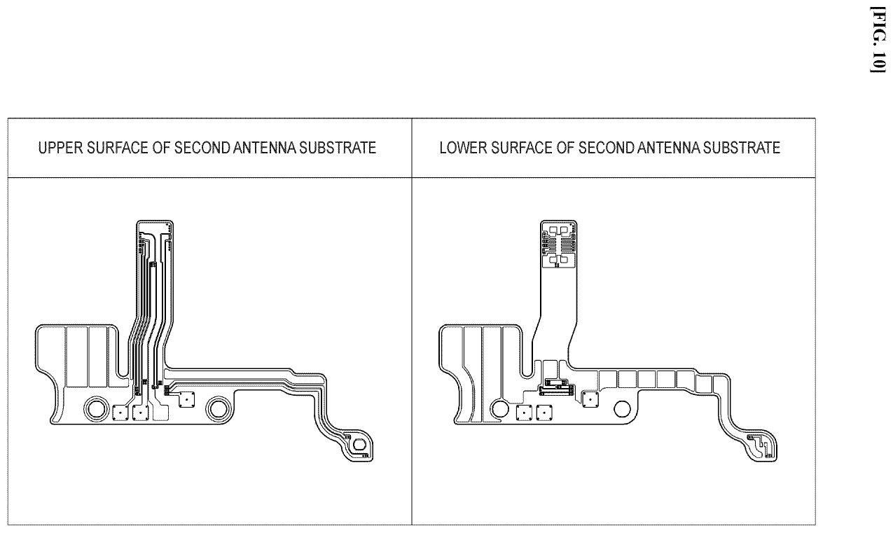

Referring to FIG. 9, the upper bonding pattern 330a and the lower bonding pattern 330b are connected through a via hole V. The upper bonding pattern 330a and the lower bonding pattern 330b each have a structure in which a fourth metal layer M1 and a fifth metal layer M2 are stacked. The fourth metal layer M1 is formed of, as an example, copper (Cu), which is mainly used as a metal pattern. The fifth metal layer M2 is a metal layer for facilitating fusion bonding, and as an example, is formed of gold (Au).

On the other hand, the first to the fourth terminal patterns 322 to 328 and the second to the fifth connection patterns 342 to 348 are each formed of only the fourth metal layer M1.

The second connection pattern 342 is disposed on the upper surface of the second base substrate 310. A first end of the second connection pattern 342 is connected to the first terminal pattern 322, and a second end of the second connection pattern 342 is connected to the first bonding pattern 332. Accordingly, the second connection pattern 342 connects the first terminal pattern 322 and the first bonding pattern 332.

The third connection pattern 344 is disposed on the upper surface of the second base substrate 310, and is disposed to be spaced apart from the second connection pattern 342. A first end of the third connection pattern 344 is connected to the second terminal pattern 324, and a second end of the third connection pattern 344 is connected to the second bonding pattern 334. Accordingly, the third connection pattern 344 connects the second terminal pattern 324 and the second bonding pattern 334.

The fourth connection pattern 346 is disposed on the upper surface of the second base substrate 310, and is disposed to be spaced apart from the second connection pattern 342 and the third connection pattern 344. A first end of the fourth connection pattern 346 is connected to the third terminal pattern 326, and a second end of the fourth connection pattern 346 is connected to the third bonding pattern 336. Accordingly, the fourth connection pattern 346 connects the third terminal pattern 326 and the third bonding pattern 336.

The fifth connection pattern 348 is disposed on the upper surface of the second base substrate 310, and is disposed to be spaced apart from the second to the fourth connection patterns 342 to 346. A first end of the fifth connection pattern 348 is connected to the fourth terminal pattern 328, and a second end of the fifth connection pattern 348 is connected to the fourth bonding pattern 338. Accordingly, the fifth connection pattern 348 connects the fourth terminal pattern 328 and the fourth bonding pattern 338.

In FIGS. 7 and 8, the patterns are illustrated in a simplified manner for ease of explanation of the second antenna substrate 300. However, the disclosure is not limited thereto, and as illustrated in FIG. 10, the second antenna substrate 300 may further include an additional terminal pattern, an antenna pattern, a thermistor connection pattern, and the like, or may be modified in various forms.

As the second antenna substrate 300 is disposed on the lower surface of the first antenna substrate 100, the bonding pattern 330 is bonded to the coil exposed through the bonding hole 116. As an example, the bonding pattern 330 and the coil are bonded through a thermal fusion bonding process.

The first bonding pattern 332 faces the second end 120b of the first coil 120 exposed through the first bonding hole 116a. The first bonding pattern 332 is bonded to the second end 120b of the first coil 120 through a thermal fusion bonding process.

The second bonding pattern 334 faces the second end 130b of the second coil 130 exposed through the second bonding hole 116b. The second bonding pattern 334 is bonded to the second end 130b of the second coil 130 through a thermal fusion bonding process.

The third bonding pattern 336 faces the first end 140a of the third coil 140 exposed through the third bonding hole 116c. The third bonding pattern 336 is bonded to the first end 140a of the third coil 140 through a thermal fusion bonding process.

The fourth bonding pattern 338 faces the second end 140b of the third coil 140 exposed through the fourth bonding hole 116d. The fourth bonding pattern 338 is bonded to the second end 140b of the third coil 140 through a thermal fusion bonding process.

The metal substrate 400 is disposed on the lower surfaces of the first antenna substrate 100 and the second antenna substrate 300. The metal substrate 400 is formed of a planar metal sheet and, as an example, is disposed on the lower surfaces of the first antenna substrate 100 and the second antenna substrate 300 to reinforce the rigidity (strength) of the antenna module.

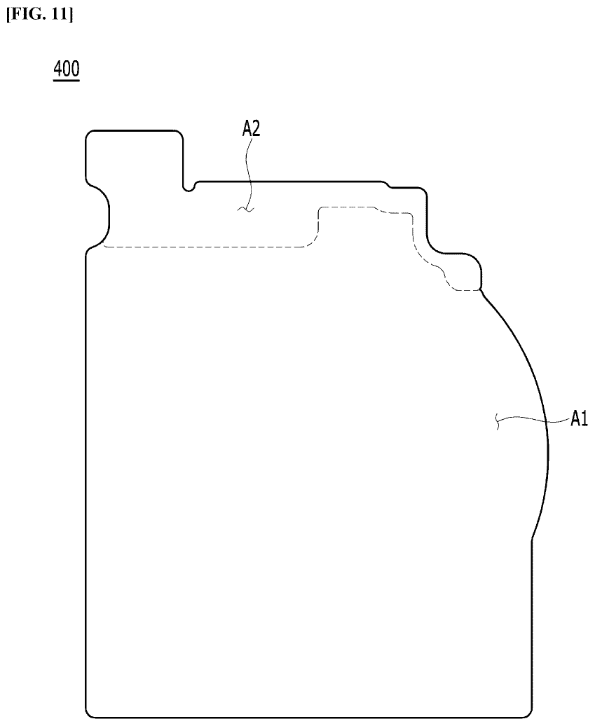

Referring to FIG. 11, as the metal substrate 400 is disposed on the lower surfaces of the first antenna substrate 100 and the second antenna substrate 300, the metal substrate 400 may be sectioned into a first area A1 and a second area A2.

The first area A1 is an area of the metal substrate 400 that overlaps the first antenna substrate 100 within an entire area of the metal substrate 400. The first area A1 overlaps at least a portion of an entire area of the first antenna substrate 100. Here, the first area A1 is an area that does not overlap the second antenna substrate 300.

The second area A2 is an area of the metal substrate 400 that overlaps the second antenna substrate 300 within the entire area of the metal substrate 400. The second area A2 is disposed to overlap at least a portion of an entire area of the second antenna substrate 300. Here, a portion of the second area A2 overlaps the first antenna substrate 100 and the second antenna substrate 300, and overlaps the first antenna substrate 100 with the second antenna substrate 300 interposed therebetween.

In the case where the second antenna substrate 300 is configured to be disposed on an upper surface of the first antenna substrate 100, a step is formed between the first antenna substrate 100 and the second antenna substrate 300 in the antenna module. Accordingly, an upper portion of the antenna module in which the step is formed faces the rear housing of the portable terminal, and during a process of mounting the antenna module in the portable terminal, at least one of the stepped region, the first antenna substrate 100, and the second antenna substrate 300 may be dented or damaged by the rear housing of the portable terminal, thereby causing deterioration in antenna performance.

Accordingly, in the antenna module according to the first embodiment of the present disclosure, the second antenna substrate 300 is disposed on the lower surface of the first antenna substrate 100 so that the step between the first antenna substrate 100 and the second antenna substrate 300 is formed on a lower surface of the antenna module. Here, the metal substrate 400 is disposed on the lower surface of the antenna module and faces the battery when the antenna module is mounted in the portable terminal. Therefore, the antenna module according to the first embodiment of the present disclosure can prevent the second antenna substrate 300 from being dented by the rear housing of the portable terminal during the process of mounting the antenna module in the portable terminal, thereby preventing deterioration of the antenna performance.

On the other hand, in the case where the second antenna substrate 300 is disposed on the lower surface of the first antenna substrate 100, when forming a pattern having a thickness of approximately 3 oz (about 105 μm) or more, a separate film or coverlay having a thickness of 20 μm is required to prevent a short circuit, thereby increasing a thickness of the antenna module.

Accordingly, in the antenna module according to the first embodiment of the present disclosure, the bonding holes are formed in the coverlay film (that is, the first sheet) to expose the ends of the coils downward, whereby an increase in thickness can be minimized even when the second antenna substrate 300 is disposed on the lower surface of the first antenna substrate 100.

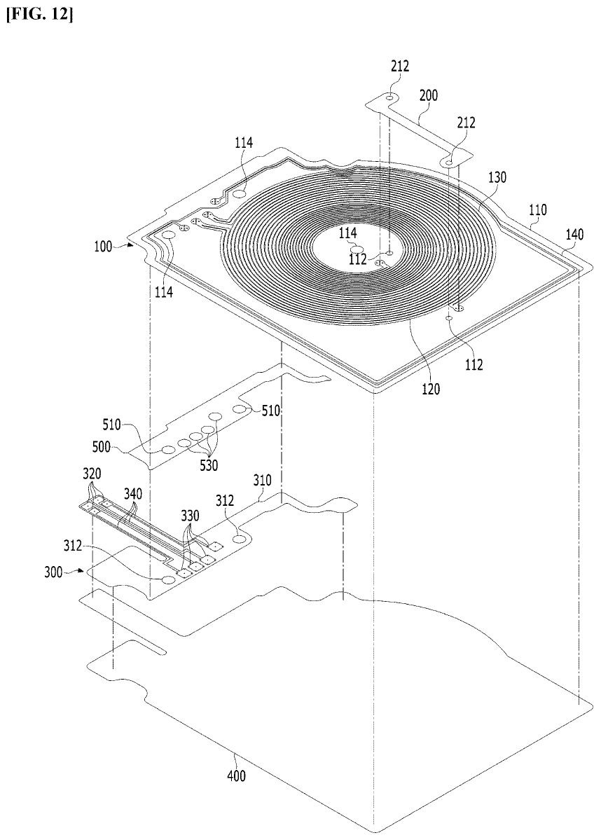

Referring to FIG. 12, the antenna module according to the first embodiment of the present disclosure may further include the adhesive substrate 500 interposed between the first antenna substrate 100 and the second antenna substrate 300 to primarily bond (provisionally bond) the first antenna substrate 100 and the second antenna substrate 300.

The adhesive substrate 500 is interposed between the first antenna substrate 100 and the second antenna substrate 300. The adhesive substrate 500 is a substrate that primarily bonds the first antenna substrate 100 and the second antenna substrate 300. As an example, a thickness of the adhesive substrate 500 is approximately 1 μm or more and approximately 20 μm or less.

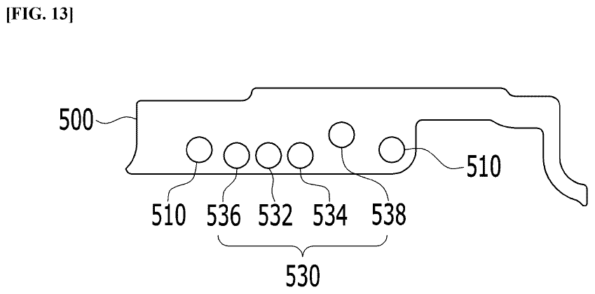

Referring to FIG. 13, one or more fifth jig holes 510 are formed in the adhesive substrate 500. The fifth jig holes 510 are formed to pass through the adhesive substrate 500 and are formed at positions corresponding to the plurality of second jig holes 114 formed in the first sheet 110 and the plurality of fourth jig holes 312 formed in the second base substrate 310. As the adhesive substrate 500 is interposed between the first antenna substrate 100 and the second antenna substrate 300, the plurality of fifth jig holes 510 overlap the plurality of second jig holes 114 and the plurality of fourth jig holes 312, thereby forming a plurality of jig holes through which the guide protrusions of the jig pass.

The plurality of bonding holes 116 are formed in the adhesive substrate 500. As an example, a fifth bonding hole 532, a sixth bonding hole 534, a seventh bonding hole 536, and an eighth bonding hole 538 are formed in the adhesive substrate 500.

The fifth bonding hole 532 is formed to pass through the adhesive substrate 500. The fifth bonding hole 532 is formed at a position corresponding to the first bonding hole 116a and the first bonding pattern 332. As the adhesive substrate 500 is interposed between the first antenna substrate 100 and the second antenna substrate 300, the fifth bonding hole 532, together with the first bonding hole 116a, exposes the first bonding pattern 332 to allow the first bonding pattern 332 to face the second end 120b of the first coil 120. Here, the first bonding pattern 332 is exposed through the first bonding hole 116a and the fifth bonding hole 532 so as to face the second end 120b of the first coil 120, and the first bonding pattern 332 and the second end 120b of the first coil 120 are secondarily bonded through a thermal fusion bonding process.

The sixth bonding hole 534 is formed to pass through the adhesive substrate 500. The sixth bonding hole 534 is formed at a position corresponding to the second bonding hole 116b and the second bonding pattern 334. As the adhesive substrate 500 is interposed between the first antenna substrate 100 and the second antenna substrate 300, the sixth bonding hole 534, together with the second bonding hole 116b, exposes the second bonding pattern 334 to allow the second bonding pattern 334 to face the second end 130b of the second coil 130. Here, the second bonding pattern 334 is exposed through the second bonding hole 116b and the sixth bonding hole 534 so as to face the second end 130b of the second coil 130, and the second bonding pattern 334 and the second end 130b of the second coil 130 are secondarily bonded through a thermal fusion bonding process.

The seventh bonding hole 536 is formed to pass through the adhesive substrate 500. The seventh bonding hole 536 is formed at a position corresponding to the third bonding hole 116c and the third bonding pattern 336. As the adhesive substrate 500 is interposed between the first antenna substrate 100 and the second antenna substrate 300, the seventh bonding hole 536, together with the third bonding hole 116c, exposes the third bonding pattern 336 to allow the third bonding pattern 336 to face the first end 140a of the third coil 140. Here, the third bonding pattern 336 is exposed through the third bonding hole 116c and the seventh bonding hole 536 so as to face the first end 140a of the third coil 140, and the third bonding pattern 336 and the first end 140a of the third coil 140 are secondarily bonded through a thermal fusion bonding process.

The eighth bonding hole 538 is formed to pass through the adhesive substrate 500. The eighth bonding hole 538 is formed at a position corresponding to the fourth bonding hole 116d and the fourth bonding pattern 338. As the adhesive substrate 500 is interposed between the first antenna substrate 100 and the second antenna substrate 300, the eighth bonding hole 538, together with the fourth bonding hole 116d, exposes the fourth bonding pattern 338 to allow the fourth bonding pattern 338 to face a second end 140b of the third coil 140. Here, the fourth bonding pattern 338 is exposed through the fourth bonding hole 116d and the eighth bonding hole 538 so as to face the second end 140b of the third coil 140, and the fourth bonding pattern 338 and the second end 140b of the third coil 140 are secondarily bonded through a thermal fusion bonding process.

In this manner, the first antenna substrate 100 and the second antenna substrate 300 are primarily bonded (provisionally bonded) by the adhesive substrate 500, and the bonding patterns 330 exposed through the bonding holes 116 of the adhesive substrate 500 and the ends of the coils are secondarily bonded (through thermal fusion bonding).

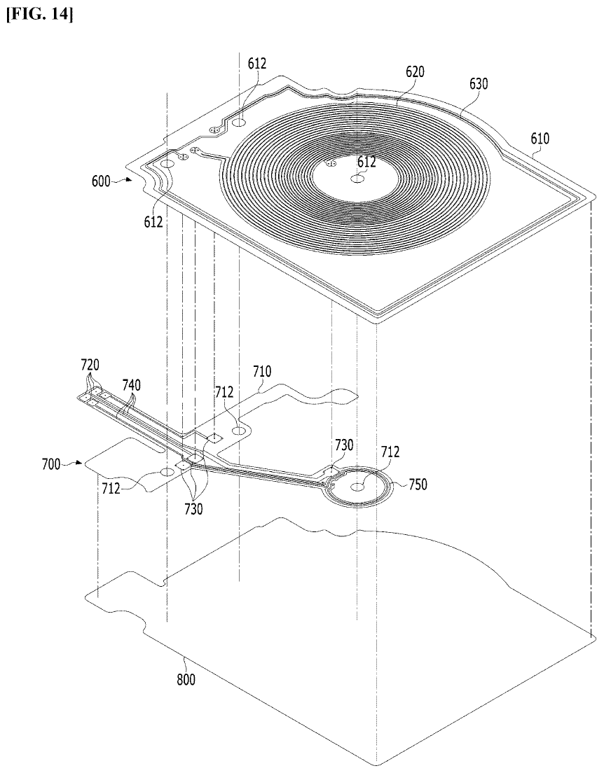

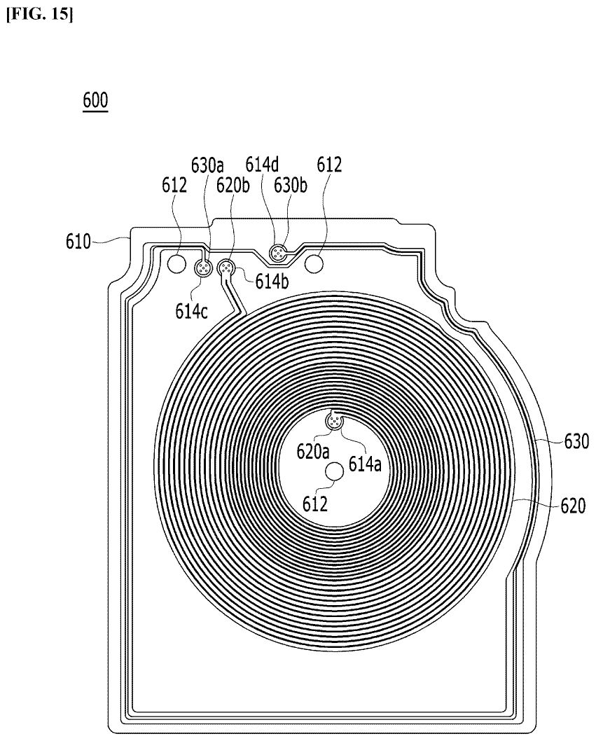

Referring to FIG. 14, the antenna module according to a second embodiment of the present disclosure is configured to include a first antenna substrate 600, a second antenna substrate 700, and a metal substrate 800. Here, the first antenna substrate 600 and the second antenna substrate 700 are bonded through a fusion bonding process. The fusion bonding process includes, as an example, a thermal fusion bonding process, and includes physically and electrically bonding the first antenna substrate 600 to the second antenna substrate 700.

Referring to FIG. 15, the first antenna substrate 600 includes a first sheet 610, a first coil 620, and a second coil 630.

A plurality of first jig holes 612 are formed in the first sheet 610 to align the first antenna substrate 600, the second antenna substrate 700, and an adhesive substrate 900 during a process of manufacturing the antenna module. The first jig holes 612 are formed to pass through the first sheet 610.

A plurality of bonding holes 614 are formed in the first sheet 610. The plurality of bonding holes 614 are formed to pass through the first sheet 610. The bonding holes 614 are formed at positions overlapping with ends of coils disposed on an upper surface of the first sheet 610. The bonding holes 614 expose the overlapping ends of the coils to a lower side of the first sheet 610. To electrically connect the coils of the first antenna substrate 600 to patterns formed on the second antenna substrate 700, the ends of the coils formed on the upper surface of the first sheet 610 are exposed to a lower surface of the first sheet 610.

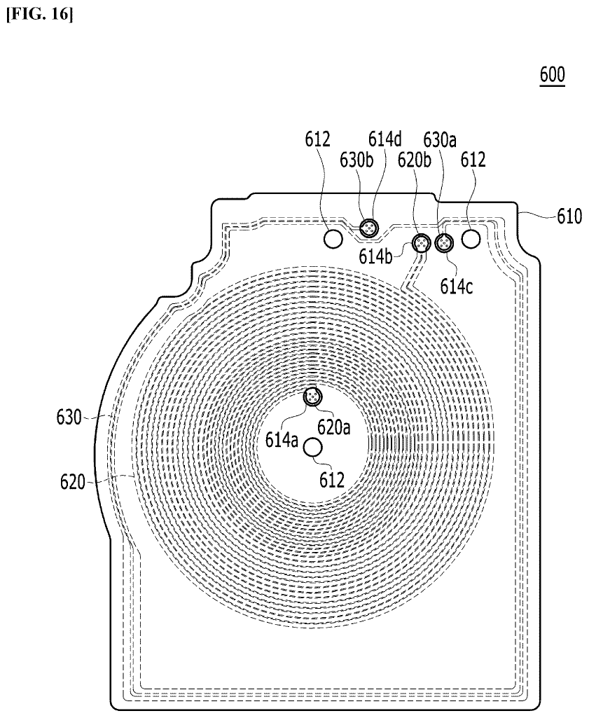

Referring to FIG. 16, a first bonding hole 614a, a second bonding hole 614b, a third bonding hole 614c, and a fourth bonding hole 614d are formed in the first sheet 610.

The first bonding hole 614a is formed at a position overlapping a first end 620a of the first coil 620 to expose the first end 620a of the first coil 620 to the lower surface of the first sheet 610. The first bonding hole 614a is formed, within an entire area of the first sheet 610, in an area overlapping the first end 620a of the first coil 620 disposed on the first sheet 610.

The second bonding hole 614b is formed at a position overlapping a second end 620b of the first coil 620 to expose the second end 620b of the first coil 620 to the lower surface of the first sheet 610. The second bonding hole 614b is formed, within the entire area of the first sheet 610, in an area overlapping the second end 620b of the first coil 620 disposed on the first sheet 610.

The third bonding hole 614c is formed at a position overlapping a first end 630a of the second coil 630 to expose the first end 630a of the second coil 630 to the lower surface of the first sheet 610. The third bonding hole 614c is formed, within the entire area of the first sheet 610, in an area overlapping the first end 630a of the second coil 630 disposed on the first sheet 610.

The fourth bonding hole 614d is formed at a position overlapping a second end 630b of the second coil 630 to expose the second end 630b of the second coil 630 to the lower surface of the first sheet 610. The fourth bonding hole 614d is formed, within the entire area of the first sheet 610, in an area overlapping the second end 630b of the second coil 630 disposed on the first sheet 610.

The first coil 620 is disposed on the upper surface of the first sheet 610. The first coil 620 may be, for example, a wireless power transfer coil.

The first coil 620 is wound a plurality of times on the upper surface of the first sheet 610 to form a first loop. The first coil 620 is wound around an imaginary first winding axis vertically penetrating the first sheet 610, thereby forming the first loop. The first end 620a of the first coil 620 is disposed in an inner circumferential area of the first loop. The second end 620b of the first coil 620 is disposed in an outer circumferential area of the first loop.

The second coil 630 is disposed on the upper surface of the first sheet 610. The second coil 630 is disposed on the upper surface of the first sheet 610 so as to be spaced apart from the first coil 620. The second coil 630 is disposed in the outer circumferential area of the first loop formed by the first coil 620. In other words, the first loop formed by the first coil 620 is disposed in an inner circumferential area of a second loop formed by the second coil 630. Here, the second coil 630 forms a second radiation coil, and as an example, the second radiation coil may be a coil for near-field communication.

The second coil 630 is wound one or more times on the upper surface of the first sheet 610 to form the second loop. The second coil 630 is wound around an imaginary second winding axis vertically penetrating the first sheet 610, thereby forming the second loop. The second winding axis may be the same axis as the first winding axis. The first end 630a of the second coil 630 is disposed in the inner circumferential area of the second loop. The second end 630b of the second coil 630 is disposed in an outer circumferential area of the second loop.

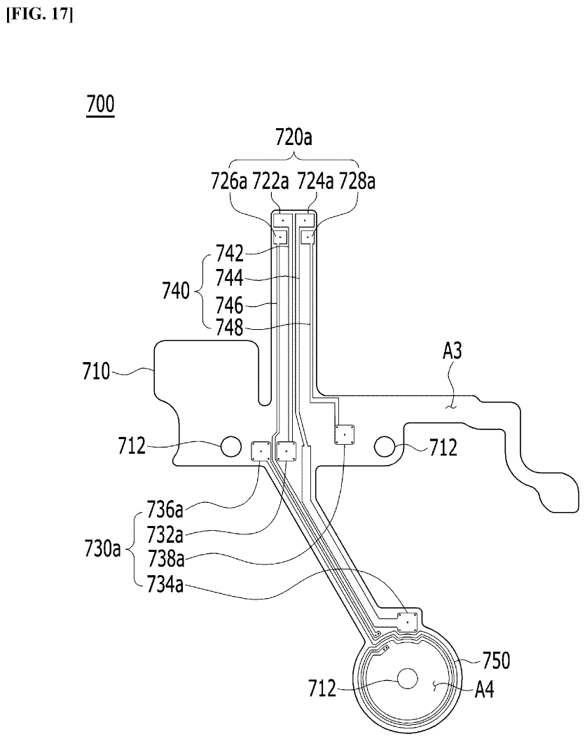

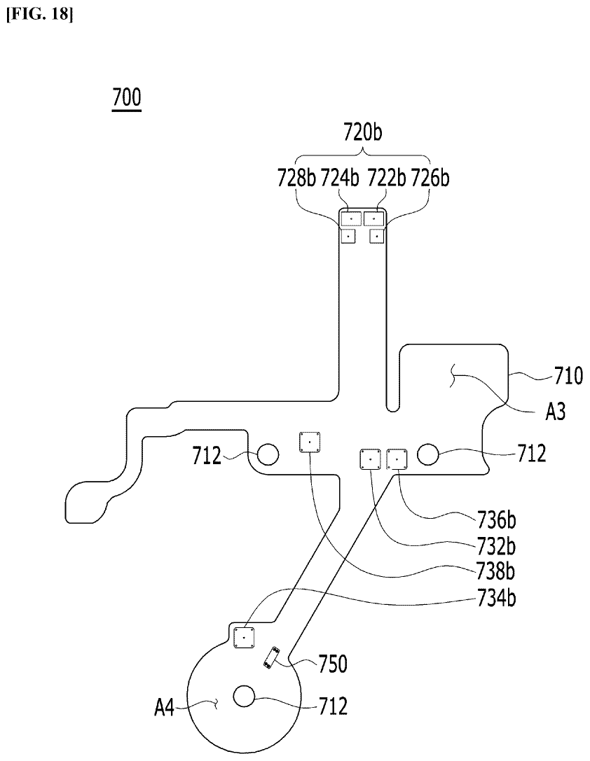

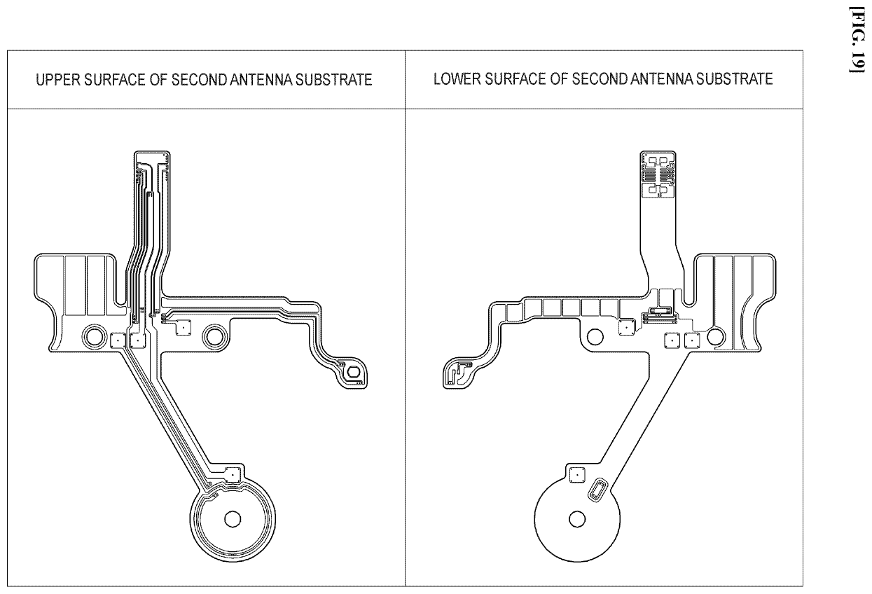

Referring to FIGS. 17 and 18, the second antenna substrate 700 is configured to include a first base substrate 710, a terminal pattern 720, a bonding pattern 730, a radiation pattern 750, a first connection pattern 742, a second connection pattern 744, a third connection pattern 746, and a fourth connection pattern 748.

The first base substrate 710 is formed of a flexible printed circuit board (FPCB). The first base substrate 710 includes a first area A3 corresponding to the second base substrate of the first embodiment, and a second area A4, which extends from the first area A3, and in which the radiation pattern 750 is formed.

A plurality of second jig holes 712 are formed in the first base substrate 710 to align the first antenna substrate 600, the second antenna substrate 700, and the adhesive substrate 900 during the process of manufacturing the antenna module. The plurality of second jig holes 712 are formed to pass through the first base substrate 710 and are formed at positions corresponding to the plurality of first jig holes 612 formed in the first sheet 610. As the second antenna substrate 700 is disposed on the upper surface of the first antenna substrate 600, the plurality of second jig holes 712 overlap the plurality of first jig holes 612 to form a plurality of jig holes through which the guide protrusions of the jig pass.

The terminal pattern 720 is a terminal that connects the first radiation coil, which is the first coil 620 and the second radiation coil formed by the second coil 630 and the radiation pattern 750, to an external device. The terminal pattern 720 may be configured to include at least one of an upper terminal pattern 720a disposed on an upper surface of the first base substrate 710 and a lower terminal pattern 720b disposed on a lower surface of the first base substrate 710.

As an example, the terminal pattern 720 is configured to include a first terminal pattern 722, a second terminal pattern 724, a third terminal pattern 726, and a fourth terminal pattern 728. The first to the fourth terminal patterns 722 to 728 are disposed to be spaced apart from each other by a predetermined interval.

The first terminal pattern 722 is connected to the first connection pattern 742. The first terminal pattern 722 may be configured to include a first upper terminal pattern 722a disposed on the upper surface of the first base substrate 710 and a first lower terminal pattern 722b disposed on the lower surface of the first base substrate 710. The first upper terminal pattern 722a and the first lower terminal pattern 722b are disposed to overlap each other with the first base substrate 710 interposed therebetween and are electrically connected through a via hole. Here, the first terminal pattern 722 may also be configured with either the first upper terminal pattern 722a or the first lower terminal pattern 722b.

The second terminal pattern 724 is connected to the second connection pattern 744. The second terminal pattern 724 may be configured to include a second upper terminal pattern 724a disposed on the upper surface of the first base substrate 710 and a second lower terminal pattern 724b disposed on the lower surface of the first base substrate 710. The second upper terminal pattern 724a and the second lower terminal pattern 724b are disposed to overlap each other with the first base substrate 710 interposed therebetween and are electrically connected through a via hole. In this case, the second terminal pattern 724 may also be configured with either the second upper terminal pattern 724a or the second lower terminal pattern 724b.

The third terminal pattern 726 is connected to the third connection pattern 746. The third terminal pattern 726 may be configured to include a third upper terminal pattern disposed on the upper surface of the first base substrate 710 and a third lower terminal pattern 726b disposed on the lower surface of the first base substrate 710. The third upper terminal pattern and the third lower terminal pattern 726b are disposed to overlap each other with the first base substrate 710 interposed therebetween and are electrically connected through a via hole. Here, the third terminal pattern 726 may also be configured with either the third upper terminal pattern or the third lower terminal pattern 726b.

The fourth terminal pattern 728 is connected to the fourth connection pattern 748. The fourth terminal pattern 728 may be configured to include a fourth upper terminal pattern disposed on the upper surface of the first base substrate 710 and a fourth lower terminal pattern 728b disposed on the lower surface of the first base substrate 710. The fourth upper terminal pattern and the fourth lower terminal pattern 728b are disposed to overlap each other with the first base substrate 710 interposed therebetween and are electrically connected through a via hole. Here, the fourth terminal pattern 728 may also be configured with either the fourth upper terminal pattern or the fourth lower terminal pattern 728b.

The bonding pattern 730 is a pattern that connects the first radiation coil and the second radiation coil to the terminal pattern 720. The bonding pattern 730 may be configured to include an upper bonding pattern 730a disposed on the upper surface of the first base substrate 710 and a lower bonding pattern 730b disposed on the lower surface of the first base substrate 710.

A first bonding pattern 732 is disposed in the first area A3 of the first base substrate 710 and connects the second end 620b of the first coil 620 to the first terminal pattern 722. That is, the first bonding pattern 732 is connected to the first connection pattern 742 and is electrically connected to the second end 620b of the first coil 620, thereby electrically connecting the second end 620b of the first coil 620 to the first terminal pattern 722.

The first bonding pattern 732 may be configured to include a first upper bonding pattern 732a disposed on the upper surface of the first base substrate 710 and a first lower bonding pattern 732b disposed on the lower surface of the first base substrate 710. The first upper bonding pattern 732a and the first lower bonding pattern 732b are disposed to overlap each other with the first base substrate 710 interposed therebetween and are electrically connected through a via hole.

The second bonding pattern 734 is disposed in the second area A4 of the first base substrate 710 and connects the first end 620a of the first coil 620 to the second terminal pattern 724. In other words, the second bonding pattern 734 is connected to the second connection pattern 744 and is electrically connected to the first end 620a of the first coil 620, thereby electrically connecting the first end 620a of the first coil 620 to the second terminal pattern 724.

The second bonding pattern 734 may be configured to include a second upper bonding pattern 734a disposed on the upper surface of the first base substrate 710 and a second lower bonding pattern 734b disposed on the lower surface of the first base substrate 710. The second upper bonding pattern 734a and the second lower bonding pattern 734b are disposed to overlap each other with the first base substrate 710 interposed therebetween and are electrically connected through a via hole.

The third bonding pattern 736 is disposed in the first area A3 of the first base substrate 710 and connects the first end 630a of the second coil 630 to a first end of a third coil. In other words, the third bonding pattern 736 is connected to the first end of the third coil and is electrically connected to the first end 630a of the second coil 630, thereby electrically connecting the first end 630a of the second coil 630 to the first end of the third coil.

The third bonding pattern 736 may be configured to include a third upper bonding pattern 736a disposed on the upper surface of the first base substrate 710 and a third lower bonding pattern 736b disposed on the lower surface of the first base substrate 710. The third upper bonding pattern 736a and the third lower bonding pattern 736b are disposed to overlap each other with the first base substrate 710 interposed therebetween and are electrically connected through a via hole.

The fourth bonding pattern 738 is disposed in the first area A3 of the first base substrate 710 and connects the second end 630b of the second coil 630 to the fourth terminal pattern 728. In other words, the fourth bonding pattern 738 is connected to the fourth connection pattern 748 and is electrically connected to the second end 630b of the second coil 630, thereby electrically connecting the second end 630b of the second coil 630 to the fourth terminal pattern 728.

The fourth bonding pattern 738 may be configured to include a fourth upper bonding pattern 738a disposed on the upper surface of the first base substrate 710 and a fourth lower bonding pattern 738b disposed on the lower surface of the first base substrate 710. The fourth upper bonding pattern 738a and the fourth lower bonding pattern 738b are disposed to overlap each other with the first base substrate 710 interposed therebetween and are electrically connected through a via hole.

The bonding pattern 730 is a fusion bonding point used in a thermal fusion bonding process of secondarily bonding the first antenna substrate 600 and the second antenna substrate 700 that are primarily bonded by the adhesive substrate 900. In other words, the first antenna substrate 600 and the second antenna substrate 700 are secondarily bonded through the thermal fusion bonding process with respect to the bonding pattern 730 and are thus electrically connected.

The upper bonding pattern 730a and the lower bonding pattern 730b are connected through a via hole. The upper bonding pattern 730a and the lower bonding pattern 730b each have a structure in which a first metal layer and a second metal layer are stacked (see FIG. 9). The first metal layer is formed of, as an example, copper (Cu), which is mainly used as a metal pattern. The second metal layer is a metal layer for facilitating thermal fusion bonding, and as an example, is formed of gold (Au).

The first to the fourth terminal patterns 722 to 728 and the first to the fourth connection patterns 742 to 748 are each formed of only the first metal layer.

The radiation pattern 750 is disposed on the upper surface of the first base substrate 710. The radiation pattern 750 is formed on the upper surface of the first base substrate 710 through a printing process. Here, the radiation pattern 750 is disposed in the second area A4 of the first base substrate 710.

The radiation pattern 750 is wound around an imaginary third winding axis vertically penetrating the first base substrate 710 to form a third loop. Here, as the second antenna substrate 700 is disposed on the upper surface of the first antenna substrate 600, the third loop is disposed to overlap the inner circumferential area of the first loop.

A first end of the radiation pattern 750 is connected to the third bonding pattern 736, and a second end of the radiation pattern 750 is connected to the third terminal pattern 726 through the third connection pattern 746. Here, the second end of the radiation pattern 750 bypasses to a lower surface of the first base substrate 710 and is connected to the third connection pattern 746.

Accordingly, the radiation pattern 750 is electrically connected to the second coil 630 to form, together with the second coil 630, the second radiation coil (that is, a coil for near-field communication). Here, the radiation pattern 750 is disposed in the inner circumferential area of the first loop formed by the first coil 620 (that is, the first radiation coil), and operates as an auxiliary radiator to minimize a shadow area of the second coil 630 (that is, the second radiation coil).

The first connection pattern 742 is disposed on an upper surface of the second base substrate. A first end of the first connection pattern 742 is connected to the first terminal pattern 722, and a second end of the first connection pattern 742 is connected to the first bonding pattern 732. Accordingly, the first connection pattern 742 connects the first terminal pattern 722 and the first bonding pattern 732.

The second connection pattern 744 is disposed on the upper surface of the second base substrate. A first end of the second connection pattern 744 is connected to the second terminal pattern 724, and a second end of the second connection pattern 744 is connected to the second bonding pattern 734. Accordingly, the second connection pattern 744 connects the second terminal pattern 724 and the second bonding pattern 734.

The third connection pattern 746 is disposed on the upper surface of the second base substrate. A first end of the third connection pattern 746 is connected to the third terminal pattern 726, and a second end of the third connection pattern 746 is connected to a second end of the radiation pattern 750. Accordingly, the third connection pattern 746 connects the third terminal pattern 726 and the radiation pattern 750.

The fourth connection pattern 748 is disposed on the upper surface of the second base substrate. A first end of the fourth connection pattern 748 is connected to the fourth terminal pattern 728, and a second end of the fourth connection pattern 748 is connected to the fourth bonding pattern 738. Accordingly, the fourth connection pattern 748 connects the fourth terminal pattern 728 and the fourth bonding pattern 738.

In FIGS. 17 and 18, the patterns are illustrated in a simplified manner for ease of explanation of the second antenna substrate 700. However, the disclosure is not limited thereto, and as illustrated in FIG. 19, the second antenna substrate 700 may further include an additional terminal pattern 720, an antenna pattern, a thermistor connection pattern, and the like, or may be modified in various forms.

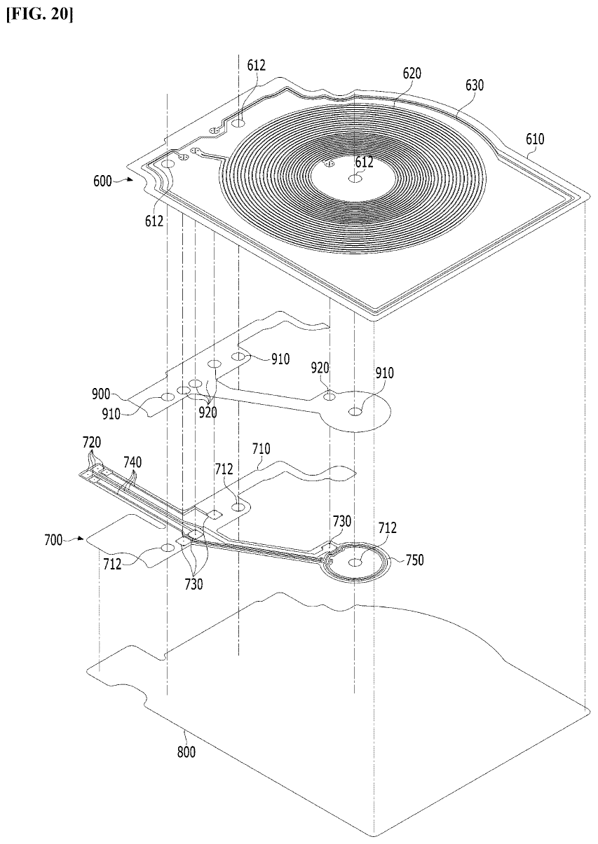

Referring to FIG. 20, the antenna module according to the second embodiment of the present disclosure may further include the adhesive substrate 900 interposed between the first antenna substrate 600 and the second antenna substrate 700 to primarily bond (provisionally bond) the first antenna substrate 600 and the second antenna substrate 700.

The adhesive substrate 900 is interposed between the first antenna substrate 600 and the second antenna substrate 700. The adhesive substrate 900 is a substrate that primarily bonds the first antenna substrate 600 and the second antenna substrate 700. As an example, a thickness of the adhesive substrate 900 is approximately 1 μm or more and approximately 20 μm or less.

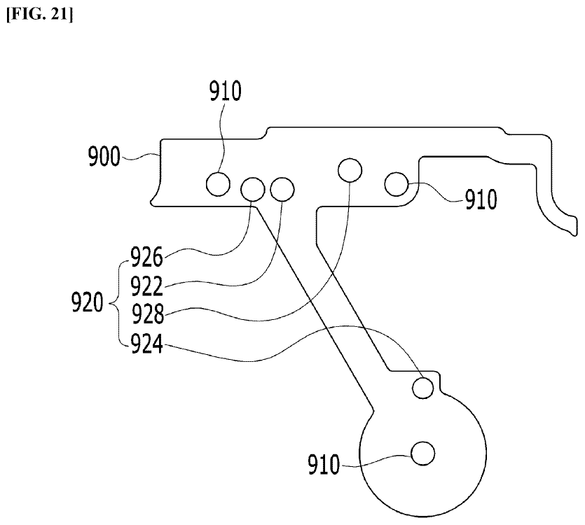

Referring to FIG. 21, a plurality of third jig holes 910 are formed in the adhesive substrate 900. The third jig holes 910 are formed to pass through the adhesive substrate 900. The third jig holes 910 are formed at positions corresponding to the plurality of first jig holes 612 formed in the first sheet 610 and the plurality of second jig holes 712 formed in the first base substrate 710. As the adhesive substrate 900 is interposed between the first antenna substrate 600 and the second antenna substrate 700, the plurality of third jig holes 910 overlap the plurality of first jig holes 612 and the plurality of second jig holes 712, thereby forming a plurality of jig holes through which guide protrusions of the jig pass.

A plurality of bonding holes 920 are formed in the adhesive substrate 900. As an example, a fifth bonding hole 922, a sixth bonding hole 924, a seventh bonding hole 926, and an eighth bonding hole 928 are formed in the adhesive substrate 900.

The fifth bonding hole 922 is formed to pass through the adhesive substrate 900. The fifth bonding hole 922 is formed at a position corresponding to the first bonding pattern 732. As the adhesive substrate 900 is interposed between the first antenna substrate 600 and the second antenna substrate 700, the fifth bonding hole 922 exposes the first bonding pattern 732 to allow the first bonding pattern 732 to face the second end 620b of the first coil 620. Here, the first bonding pattern 732 is exposed through the fifth bonding hole 922 so as to face the second end 620b of the first coil 620, and the first bonding pattern 732 and the second end 620b of the first coil 620 are secondarily bonded through a thermal fusion bonding process.

The sixth bonding hole 924 is formed to pass through the adhesive substrate 900. The sixth bonding hole 924 is formed at a position corresponding to the second bonding pattern 734. As the adhesive substrate 900 is interposed between the first antenna substrate 600 and the second antenna substrate 700, the sixth bonding hole 924 exposes the second bonding pattern 734 to allow the second bonding pattern 734 to face the first end 620a of the first coil 620. Here, the second bonding pattern 734 is exposed through the sixth bonding hole 924 so as to face the first end 620a of the first coil 620, and the second bonding pattern 734 and the first end 620a of the first coil 620 are secondarily bonded through a thermal fusion bonding process.

The seventh bonding hole 926 is formed to pass through the adhesive substrate 900. The seventh bonding hole 926 is formed at a position corresponding to the third bonding pattern 736. As the adhesive substrate 900 is interposed between the first antenna substrate 600 and the second antenna substrate 700, the seventh bonding hole 926 exposes the third bonding pattern 736 to allow the third bonding pattern 736 to face the first end 630a of the second coil 630. Here, the third bonding pattern 736 is exposed through the seventh bonding hole 926 so as to face the first end 630a of the second coil 630, and the third bonding pattern 736 and the first end of the third coil are secondarily bonded through a thermal fusion bonding process.

The eighth bonding hole 928 is formed to pass through the adhesive substrate 900. The eighth bonding hole 928 is formed at a position corresponding to the fourth bonding pattern 738. As the adhesive substrate 900 is interposed between the first antenna substrate 600 and the second antenna substrate 700, the eighth bonding hole 928 exposes the fourth bonding pattern 738 to allow the fourth bonding pattern 738 to face the second end 630b of the second coil 630. Here, the fourth bonding pattern 738 is exposed through the eighth bonding hole 928 so as to face the second end 630b of the second coil 630, and the fourth bonding pattern 738 and the second end 630b of the second coil 630 are secondarily bonded through a thermal fusion bonding process.

The first antenna substrate 600 and the second antenna substrate 700 are primarily bonded (provisionally bonded) by the adhesive substrate 900, and the bonding patterns 730 exposed through the bonding holes 920 of the adhesive substrate 900 and the ends of the coils are secondarily bonded (through thermal fusion bonding).

The metal substrate 800 is disposed on the lower surfaces of the first antenna substrate 600 and the second antenna substrate 700. The metal substrate 800 disposed on the lower surfaces of the first antenna substrate 600 and the second antenna substrate 700 reinforces the rigidity (strength) of the antenna module.

As the metal substrate 800 is disposed on the lower surfaces of the first antenna substrate 600 and the second antenna substrate 700, the metal substrate 800 may be sectioned into a first area and a second area.

The first area is an area of the metal substrate 800 that overlaps the first antenna substrate 600 within an entire area of the metal substrate 800. The first area overlaps at least a portion of an entire area of the first antenna substrate 600. Here, the first area is an area that does not overlap the second antenna substrate 700.

The second area is an area of the metal substrate 800 that overlaps the second antenna substrate 700 within the entire area of the metal substrate 800. The second area is disposed to overlap at least a portion of an entire area of the second antenna substrate 700. Here, a portion of the second area overlaps the first antenna substrate 600 and the second antenna substrate 700, and overlaps the first antenna substrate 600 with the second antenna substrate 700 interposed therebetween.

In the case where the second antenna substrate 700 is configured to be disposed on the upper surface of the first antenna substrate 600, a step is formed between the first antenna substrate 600 and the second antenna substrate 700 in the antenna module. Accordingly, an upper portion of the antenna module in which the step is formed faces the rear housing of the portable terminal, and during a process of mounting the antenna module in the portable terminal, at least one of the stepped region, the first antenna substrate 600, and the second antenna substrate 700 may be dented or damaged by the rear housing of the portable terminal, thereby causing deterioration in antenna performance.

Accordingly, in the antenna module according to the second embodiment of the present disclosure, the second antenna substrate 700 is disposed on the lower surface of the first antenna substrate 600 so that the step between the first antenna substrate 600 and the second antenna substrate 700 is formed on a lower surface of the antenna module. Here, the metal substrate 800 is disposed on the lower surface of the antenna module and faces the battery when the antenna module is mounted in the portable terminal. Therefore, the antenna module according to the second embodiment of the present disclosure can prevent the second antenna substrate 700 from being dented by the rear housing of the portable terminal during the process of mounting the antenna module in the portable terminal, thereby preventing deterioration of antenna performance.

On the other hand, in the case where the second antenna substrate 700 is disposed on the lower surface of the first antenna substrate 600, when forming a pattern having a thickness of approximately 3 oz (about 105 μm) or more, a separate film or coverlay having a thickness of 20 μm is required to prevent a short circuit, thereby increasing a thickness of the antenna module.

Accordingly, in the antenna module according to the second embodiment of the present disclosure, the bonding holes are formed in the coverlay film (that is, the first sheet) to expose the ends of the coils downward, whereby an increase in thickness can be minimized even when the second antenna substrate 700 is disposed on the lower surface of the first antenna substrate 600.

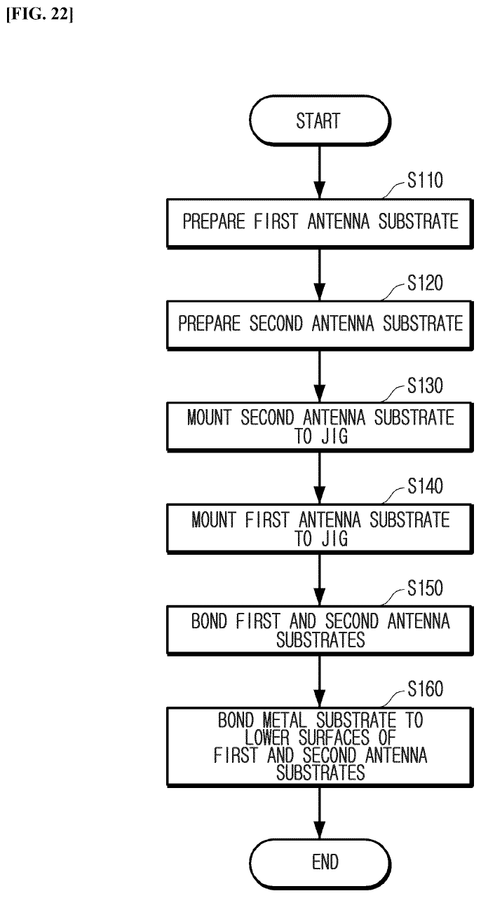

Referring to FIG. 22, a method of manufacturing the antenna module according to an embodiment of the present disclosure includes a first antenna substrate preparation step S110, a second antenna substrate preparation step S120, a second antenna substrate mounting step S130, a first antenna substrate mounting step S140, an antenna substrate bonding step S150, and a metal substrate bonding step S160.

In the first antenna substrate preparation step S110, a first antenna substrate in which one or more coils operating as a radiator are formed is prepared. As an example, in the first antenna substrate preparation step S110, the first antenna substrate is prepared to include a first sheet having a plurality of jig holes and one or more bonding holes formed therein, and one or more coils formed on the first sheet to form a radiation coil. The jig holes are holes formed to align the first antenna substrate and the second antenna substrate. The bonding holes are holes formed in areas overlapping opposite ends of the radiation coil within an entire area of the first sheet to expose the opposite ends of the radiation coil to a lower side of the first sheet.

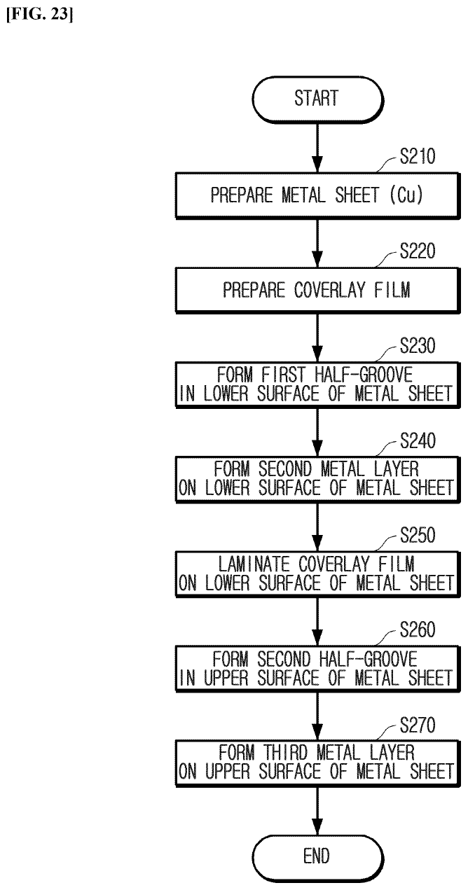

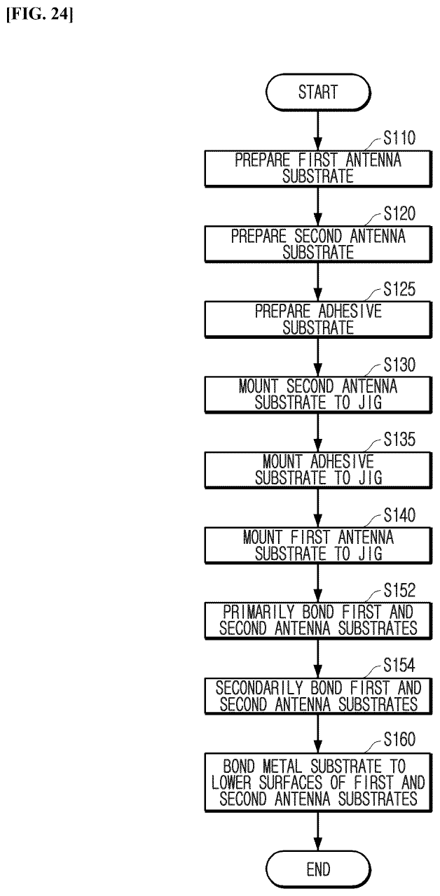

Referring to FIG. 23, the first antenna substrate preparation step S110 includes a metal sheet preparation step S210, a coverlay film preparation step S220, a first half-groove forming step S230, a second metal layer forming step S240, a coverlay film laminating step S250, a second half-groove forming step S260, and a third metal layer forming step S270.

In the metal sheet preparation step S210, a metal sheet for forming a first metal layer of each coil is prepared. As an example, in the metal sheet preparation step S210, a metal sheet made of copper (Cu), which is generally used for radiators, is prepared.

In the coverlay film preparation step S220, a coverlay film in which jig holes and bonding holes are formed is prepared. In the coverlay film preparation step S220, the coverlay film in which the plurality of jig holes are formed to align the first antenna substrate and the second antenna substrate in a process of manufacturing the antenna module is prepared. In the coverlay film preparation step S220, the coverlay film in which the plurality of bonding holes are further formed to expose the ends of the coils formed by the metal sheet to a lower side of the coverlay film is prepared.

In the first half-groove forming step S230, a first half-groove is formed in an upper surface of the metal sheet to form the coils. In the first half-groove forming step S230, the upper surface of the metal sheet is half-punched or half-etched to form the first half-groove in the upper surface of the metal sheet.

In the second metal layer forming step S240, a second metal layer is formed on the upper surface of the metal sheet (the upper surface of the metal sheet in the drawings) through an oxide process. In the second metal layer forming step S240, the second metal layer is formed on a lower surface of the first metal layer through a brown oxide process or a black oxide process. Here, the second metal layer is a blackened layer formed through the oxide process by oxidizing the lower surface of the first metal layer, and appears black or brown depending on the oxide process.

The second metal layer formed through the second metal layer forming step S240 includes a plurality of irregularities (needles, bends) formed in a direction toward the coverlay film from the first metal layer. The second metal layer formed through the second metal layer forming step S240 is formed by oxidizing the lower surface of the first metal layer through an oxide process, and includes a plurality of needles formed as a result of the oxidation treatment.

In the coverlay film laminating step S250, the coverlay film is laminated on the upper surface of the metal sheet on which the second metal layer is formed. As an example, in the coverlay film laminating step S250, the coverlay film formed of a material such as PI, PET, or a thermosetting resin is laminated on the upper surface of the metal sheet on which the second metal layer is formed.

In the coverlay film laminating step S250, the coverlay film is laminated with the metal sheet such that the bonding holes formed in the coverlay film overlap areas of the metal sheet where the ends of the coils are formed. Accordingly, the areas of the metal sheet in which the ends of the coils are formed are exposed to a lower surface of the coverlay film.

In the second half-groove forming step S260, a second half-groove is formed in the lower surface of the metal sheet to form the coils. In the second half-groove forming step S260, the lower surface of the metal sheet is half-punched or half-etched to form the second half-groove in the lower surface of the metal sheet.

In the second half-groove forming step S260, the second half-groove is formed such that at least a portion thereof overlaps the first half-groove formed in the metal sheet. Accordingly, the first half-groove and the second half-groove form a through hole passing through the metal sheet, and the through hole defines a line spacing of the coils formed by the metal sheet.

In the third metal layer forming step S270, a third metal layer is formed on the upper surface of the metal sheet (the upper surface of the metal sheet in the drawings). In the third metal layer forming step S270, the third metal layer is formed on the upper surface of the metal sheet by coating the upper surface of the metal sheet with tin (Sn) or an organic solderability preservative (OSP).

In the second antenna substrate preparation step S120, as an example, the second antenna substrate is prepared, which includes a first base substrate formed with a plurality of jig holes, a plurality of terminal patterns formed on the first base substrate, a plurality of bonding patterns formed on the first base substrate, and a plurality of connection patterns formed on the first base substrate to connect the plurality of terminal patterns and the plurality of bonding patterns.

In the second antenna substrate mounting step S130, the second antenna substrate is mounted to a jig for manufacturing the antenna module. In the second antenna substrate mounting step S130, the second antenna substrate is mounted to the jig such that a plurality of guide protrusions formed on the jig are inserted through the plurality of jig holes formed in the second antenna substrate.

In the first antenna substrate mounting step S140, the first antenna substrate is mounted to the jig to which the second antenna substrate is mounted. In the first antenna substrate mounting step S140, the first antenna substrate is mounted to the jig such that the plurality of guide protrusions formed on the jig are inserted through the plurality of jig holes formed in the first antenna substrate. Through the first antenna substrate mounting step S140, the first antenna substrate is disposed on the upper surface of the second antenna substrate. Here, in the first antenna substrate mounting step S140, the first antenna substrate is mounted to the jig such that the bonding holes of the first antenna substrate overlap bonding patterns of the second antenna substrate.

In the antenna substrate bonding step S150, the first antenna substrate and the second antenna substrate mounted to the jig are bonded to each other. In the antenna substrate bonding step S150, the opposite ends of the coils of the first antenna substrate are exposed through the bonding holes formed in the first sheet to face the bonding patterns of the second antenna substrate, and through a thermal fusion bonding process, heat is applied to the bonding patterns of the second antenna substrate or to the ends of the coils to bond the ends of the coils formed in the first antenna substrate to the bonding patterns of the second antenna substrate.

In the metal substrate bonding step S160, a planar metal substrate is bonded to the lower surfaces of the first antenna substrate and the second antenna substrate. As an example, in the metal substrate bonding step S160, the metal substrate is bonded to the lower surfaces of the first antenna substrate and the second antenna substrate through an adhesive sheet. Accordingly, the metal substrate is disposed on the lower surface of the antenna module, which faces the battery embedded in the portable terminal when the antenna module is mounted in the portable terminal.

Referring to FIG. 24, the method of manufacturing the antenna module according to an embodiment of the present disclosure may further include an adhesive substrate preparation step S125 and an adhesive substrate mounting step S130.

In the adhesive substrate preparation step S125, an adhesive substrate in which a plurality of jig holes and a plurality of bonding holes are formed is prepared. Here, the bonding holes are holes that expose the bonding patterns of the second antenna substrate.

In the adhesive substrate mounting step S130, the adhesive substrate is mounted to the jig to which the second antenna substrate is mounted. In the adhesive substrate mounting step S130, the adhesive substrate is mounted to the jig such that the plurality of guide protrusions formed on the jig are inserted through the plurality of jig holes formed in the adhesive substrate. Through the adhesive substrate mounting step S130, the adhesive substrate is disposed on the upper surface of the second antenna substrate. Here, in the adhesive substrate mounting step S130, the adhesive substrate is mounted to the jig such that the ends of the coils formed in the second antenna substrate overlap the bonding holes formed in the adhesive substrate.

In the first antenna substrate mounting step S140, the first antenna substrate is mounted to the jig to which the second antenna substrate and the adhesive substrate are mounted. In the first antenna substrate mounting step S140, the first antenna substrate is mounted to the jig such that the plurality of guide protrusions formed on the jig are inserted through the plurality of jig holes formed in the first antenna substrate. Through the first antenna substrate mounting step S140, the first antenna substrate is disposed on the upper surface of the adhesive substrate. Here, in the first antenna substrate mounting step S140, the first antenna substrate is mounted to the jig such that the bonding patterns of the first antenna substrate overlap the bonding holes formed in the adhesive substrate.

As the adhesive substrate preparation step S125 and the adhesive substrate mounting step S130 are added, the antenna substrate bonding step S150 includes a primary bonding step S152 and a secondary bonding step S154.

In the primary bonding step S152, with the second antenna substrate, the adhesive substrate, and the first antenna substrate sequentially stacked and mounted to the jig, the second antenna substrate is pressed, thereby primarily bonding (provisionally bonding) the first antenna substrate and the second antenna substrate. Here, through the primary bonding step S152, the ends of the coils formed in the first antenna substrate are disposed to face the bonding patterns formed in the second antenna substrate through the bonding holes.

In the secondary bonding step S154, the first antenna substrate and the second antenna substrate that are primarily bonded through the step S152 are secondarily bonded. In the secondary bonding step S154, through a thermal fusion bonding process, the ends of the coils formed in the first antenna substrate and the bonding patterns of the second antenna substrate are bonded by applying heat to the bonding patterns of the second antenna substrate. In the secondary bonding step S154, the opposite ends of the radiation coil of the first antenna substrate are exposed through the bonding holes formed in the first sheet to face the bonding patterns of the second antenna substrate, and through the thermal fusion bonding process, heat is applied to the bonding patterns of the second antenna substrate or to the ends of the coils to bond the ends of the coils formed in the first antenna substrate and the bonding patterns of the second antenna substrate.

The above description is merely an illustrative description of the technical spirit of the present disclosure, and those skilled in the art may change and modify the present disclosure in various ways without departing from the essential characteristic of the present disclosure. Accordingly, the embodiments described in the present disclosure should not be construed as limiting the technical spirit of the present disclosure, but should be construed as describing the technical spirit of the present disclosure. The technical spirit of the present disclosure is not restricted by the embodiments. The range of protection of the present disclosure should be construed based on the following claims, and all of technical spirits within an equivalent range of the present disclosure should be construed as being included in the scope of rights of the present disclosure.

1. An antenna module, comprising:
a first antenna substrate on which a coil is formed; and
a second antenna substrate disposed under the first antenna substrate and on which a bonding pattern bonded to the coil is formed,
wherein the first antenna substrate includes a first sheet having a bonding hole formed in an area overlapping the bonding pattern, and
wherein an end of the coil is exposed to a lower side of the first antenna substrate through the bonding hole and disposed to face the bonding pattern.

2. The antenna module of claim 1, further comprising a metal substrate disposed under the first antenna substrate and the second antenna substrate,
wherein the metal substrate comprises:
a first area overlapping the first antenna substrate; and
a second area overlapping the second antenna substrate,
wherein a portion of the second area overlaps the first antenna substrate with the second antenna substrate interposed therebetween.

3. The antenna module of claim 1, wherein a cross-section of the coil comprises:
a first metal layer; and
a second metal layer disposed under the first metal layer,
wherein the second metal layer comprises a brown oxide layer or a black oxide layer formed by oxidizing a lower portion of the first metal layer through an oxide process.

4. The antenna module of claim 3, wherein the cross-section of the coil further comprises a third metal layer disposed on an upper portion of the first metal layer.

5. The antenna module of claim 1, wherein the first antenna substrate further comprises:
a first coil configured to form a first loop wound on an upper surface of the first sheet; and
a second coil configured to form a second loop wound on the upper surface of the first sheet,
wherein the first sheet includes:
a first bonding hole formed at a position overlapping a first end of the first coil, and formed to expose the first end of the first coil to a lower surface of the first sheet;
a second bonding hole formed at a position overlapping a second end of the first coil, and formed to expose the second end of the first coil to the lower surface of the first sheet;
a third bonding hole formed at a position overlapping a first end of the second coil, and formed to expose the first end of the second coil to the lower surface of the first sheet; and
a fourth bonding hole formed at a position overlapping a second end of the second coil, and formed to expose the second end of the second coil to the lower surface of the first sheet.

6. The antenna module of claim 5, further comprising an adhesive substrate interposed between the first antenna substrate and the second antenna substrate,
wherein the adhesive substrate includes:
a fifth bonding hole formed to overlap the first end of the first coil and the first bonding hole and expose the first end of the first coil to a lower surface of the first antenna substrate;
a sixth bonding hole formed to overlap the second end of the first coil and the second bonding hole and expose the second end of the first coil to the lower surface of the first antenna substrate;
a seventh bonding hole formed to overlap the first end of the second coil and the third bonding hole and expose the first end of the second coil to the lower surface of the first antenna substrate; and
an eighth bonding hole formed to overlap the second end of the second coil and the fourth bonding hole and expose the second end of the second coil to the lower surface of the first antenna substrate.

7. The antenna module of claim 5, wherein the second antenna substrate comprises:
a first base substrate disposed under the first sheet;
a first bonding pattern disposed on an upper surface of the first base substrate and connected to the first end of the first coil;
a second bonding pattern disposed on the upper surface of the first base substrate so as to be spaced apart from the first bonding pattern, and connected to the second end of the first coil;
a third bonding pattern disposed on the upper surface of the first base substrate so as to be spaced apart from the first bonding pattern and the second bonding pattern, and connected to the first end of the second coil; and
a fourth bonding pattern disposed on the upper surface of the first base substrate so as to be spaced apart from the first to the third bonding patterns, and connected to the second end of the second coil.

8. The antenna module of claim 1,
wherein the first antenna substrate comprises:
a first coil configured to form a first loop wound on an upper surface of the first sheet;
a second coil disposed on the upper surface of the first sheet; and
a third coil configured to form a second loop wound on the upper surface of the first sheet,
wherein the first sheet includes:
a first bonding hole formed at a position overlapping a second end of the first coil, and formed to expose the second end of the first coil to a lower surface of the first sheet;
a second bonding hole formed at a position overlapping a second end of the second coil, and formed to expose the second end of the second coil to the lower surface of the first sheet;
a third bonding hole formed at a position overlapping a first end of the third coil, and formed to expose the first end of the third coil to the lower surface of the first sheet; and
a fourth bonding hole formed at a position overlapping a second end of the third coil, and formed to expose the second end of the third coil to the lower surface of the first sheet.

9. The antenna module of claim 8, further comprising an adhesive substrate interposed between the first antenna substrate and the second antenna substrate,
wherein the adhesive substrate includes:
a fifth bonding hole formed to overlap the second end of the first coil and the first bonding hole and expose the second end of the first coil to a lower surface of the first antenna substrate;
a sixth bonding hole formed to overlap the second end of the second coil and the second bonding hole and expose the second end of the second coil to the lower surface of the first antenna substrate;
a seventh bonding hole formed to overlap the first end of the third coil and the third bonding hole and expose the first end of the third coil to the lower surface of the first antenna substrate; and
an eighth bonding hole formed to overlap the second end of the third coil and the fourth bonding hole and expose the second end of the third coil to the lower surface of the first antenna substrate.

10. The antenna module of claim 8, further comprising a connection substrate disposed on an upper surface of the first antenna substrate,
wherein the connection substrate comprises a connection pattern configured to connect the first coil and the second coil,
wherein a first end of the connection pattern is connected to a first end of the first coil, and a second end of the connection pattern is connected to a first end of the second coil.

11. The antenna module of claim 8, wherein the second antenna substrate comprises:
a first base substrate disposed under the first sheet;
a first bonding pattern disposed on an upper surface of the first base substrate and connected to the second end of the first coil;
a second bonding pattern disposed on the upper surface of the first base substrate so as to be spaced apart from the first bonding pattern, and connected to the second end of the second coil;
a third bonding pattern disposed on the upper surface of the first base substrate so as to be spaced apart from the first bonding pattern and the second bonding pattern, and connected to the first end of the third coil; and
a fourth bonding pattern disposed on the upper surface of the first base substrate so as to be spaced apart from the first to the third bonding patterns, and connected to the second end of the third coil.

12. A method of manufacturing an antenna module, comprising:
preparing a first antenna substrate on which a coil is formed;
preparing a second antenna substrate;
mounting the second antenna substrate to a jig;
mounting the first antenna substrate to the jig such that the first antenna substrate is disposed on an upper portion of the second antenna substrate; and
bonding the first antenna substrate and the second antenna substrate,
wherein, in the preparing of the first antenna substrate, the first antenna substrate in which an end of the coil is exposed to a lower side of the first antenna substrate through a bonding hole is prepared.

13. The method of claim 12, wherein, in the preparing of the first antenna substrate, the first antenna substrate is prepared, the first antenna substrate including the coil having a cross-section including a first metal layer and a second metal layer disposed under the first metal layer and formed by oxidizing the first metal layer.

14. The method of claim 12, wherein the preparing of the first antenna substrate comprises:
preparing a metal sheet;
preparing a coverlay film;
forming a first half-groove in an upper surface of the metal sheet;
forming a second metal layer on the upper surface of the metal sheet in which the first half-groove is formed;
laminating the coverlay film on the upper surface of the metal sheet on which the second metal layer is formed; and
forming a second half-groove in a lower surface of the metal sheet,
wherein, in the preparing of the coverlay film, the coverlay film having a bonding hole formed to expose an end of a coil formed by the metal sheet is prepared.

15. The method of claim 14, wherein, in the preparing of the second metal layer, a brown oxide layer or a black oxide layer is formed by oxidizing a lower portion of the metal sheet through an oxide process.

16. The method of claim 14, wherein the preparing of the first antenna substrate further comprises forming a third metal layer on a lower surface of the metal sheet in which the second half-groove is formed.

17. The method of claim 14, wherein, in the laminating of the coverlay film, the coverlay film is laminated such that the bonding hole formed in the coverlay film overlaps the end of the coil.

18. The method of claim 14, further comprising, before the laminating of the coverlay film, mounting an adhesive substrate to the jig such that the adhesive substrate is disposed on an upper portion of the second antenna substrate.

19. The method of claim 18,
wherein, in the mounting of the adhesive substrate, the adhesive substrate having a bonding hole in an area overlapping the end of the coil formed by the metal sheet is mounted, and
wherein the bonding hole of the adhesive substrate overlaps the bonding hole of the first antenna substrate.

20. The method of claim 12, further comprising bonding a metal substrate to a lower surface of the first antenna substrate and a lower surface of the second antenna substrate,
wherein a first area of the metal substrate overlaps the first antenna substrate,
wherein a second area of the metal substrate overlaps the second antenna substrate, and
wherein a portion of the second area overlaps the first antenna substrate with the second antenna substrate interposed therebetween.
